(19) United States
(12) Patent Application Publication
(10) Pub. No.: US 2005/0157884 A1
(43) Pub. Date: Jul. 21, 2005

(54) Audio encoding apparatus and frame region allocation circuit for audio encoding apparatus

(76) Inventor: Nobuhide Eguchi, Yokohama (JP)

Correspondence Address: KATTEN MUCHIN ROSENMAN LLP, 575 MADISON AVENUE, NEW YORK, NY, 10022-2585, US

(21) Appl. No.: 10/858,996

(22) Filed: Jun. 2, 2004

(30) Foreign Application Priority Data
Jan. 16, 2004 (JP) 2004-009743

(51) Int. Cl. H04R 5/00

(52) U.S. Cl. 381/23; 381/1

(57) ABSTRACT

An audio encoding apparatus for stereo audio encoding an L-channel PCM signal and an R-channel PCM signal efficiently allocates encoded data of the L-channel and the R-channel without varying an existing format and performs MS stereo on/off control and controls of a bit allocation amount or a frame region for the inputted PCM signals while miniaturization of the apparatus can be anticipated. A correlation degree calculation section calculates, based on the PCM signals of the L-channel and the R-channel, a correlation degree between the PCM signals, and decision section decides whether or not a stereo encoding process should be performed based on the calculated correlation degree. An allocation section allocates regions for individually storing a difference signal and a sum signal between the PCM signals based on a result of the decision, and an audio encoding section encodes the difference signal and the sum signal based on the allocated regions.

### BACKGROUND OF THE INVENTION

1) Field of the Invention

The present invention relates to an audio encoding apparatus which employs a digital compression encoding method such as, for example, the MP3 (MPEG3 Layer 3), the MPEG2-AAC (Moving Picture Experts Group 2—Advanced Audio Coding) or the like, and more particularly to an audio encoding apparatus having an MS stereo (Middle/Sides stereophonic) function and a frame region allocation circuit for an audio encoding apparatus.

2) Description of the Related Art

With the progress of a digital compression technique in recent years, a portable terminal, a personal computer and so forth are formed so as to be ready for several data formats such as text, audio (audio frequency), sound, and video data formats.

A compression encoding method for an audio signal (audio data or audio signal data) is standardized as the MPEG1 Audio by the MPEG, and three different modes of the Layer 1 to the Layer 3 are prescribed. The standards include, for example, the MP3 regarding the MPEG1, the AAC regarding the MPEG2 and so forth. Further, the encoding algorithms of the MP3 and the MPEG2-ACC are standardized as the ISO/IEC (International Organization for Standardization/International Electrotechnical Commission) NO. 11172-3 and the ISO/IEC No. 13818-7, respectively.

While the MP3 is conventionally used popularly, with the progress of a compression technique and popularization of the Internet in recent years, the AAC is adopted. It is a characteristic of the AAC that a low data rate can be used for compression and the sound quality of a decoded audio signal is high. Further, the AAC is ready for a multi-channel audio encoding method and requires a comparatively small processing amount for decoding.

Accordingly, the AAC has a compression efficiency higher than those of the compression formats of the MP3 and so forth, and decoded sound data encoded using the AAC have a high sound quality. Therefore, the AAC is popularized as an audio encoding apparatus optimum for various fields such as the fields of the Internet, a digital CD (Compact Disc), a digital video tape recorder and a digital broadcast.

In recommendations issued in the standardizations, although a decoding process is described in detail, as regards an encoding process, only an outline of an encoding algorithm is presented. An outline of the recommended encoding algorithms is given in (i) to (iii) below.

(i) An encoding apparatus performs frequency conversion for an inputted audio signal. Here, the audio signal is a sound signal acquired by a microphone, an amplifier or the like.

(ii) An encoding apparatus decides, regarding frequency components produced by the frequency conversion, a quantization error (masking characteristic) acceptable to each frequency band utilizing an acoustic sense characteristic of the human being.

(iii) An encoding apparatus encodes the frequency components converted as recited in (i) and gains of the frequency bands so that quantization noise appearing upon dequantization from quantization may be lower than the masking characteristics decided as recited in (ii).

Accordingly, regarding the encoding process, it is only necessary for the format (grammar) of a bit string (bit stream) produced by encoding an audio signal to conform to the recommendations. Meanwhile, as an audio decoding apparatus, an apparatus which conforms, for example, to the ISO standard is used. In particular, it is only necessary for the format of the encoded bit stream to be decoded based on a decoding algorithm determined in advance, and there is a comparatively high degree of freedom within the range of the encoding algorithm. Therefore, there is no strict provision regarding the number of bits necessary to encode various parameters.

Meanwhile, since the audio decoding apparatus is ready only for the decoding algorithm conforming to the recommendations, it cannot perform a process different from the process determined in accordance with the recommendations or specifications.

Further, a DVD (Digital Versatile Disk) encoder, a digital camera, a digital movie and so forth are popularly used in recent years, and a stereo type signal having an L-channel (Left Channel) and an R-channel (Right Channel) is used as an audio signal. As a method which uses a stereo type signal, an MS (Middle/Sides) stereo method is known. The MS stereo method produces and processes an M-channel signal which is a sum of an L-channel signal and an R-channel signal and an S-channel signal which is a difference between the R-channel signal and the L-channel signal.

Also regarding a relationship between an MS stereo function and the encoding algorithm described above, the recommendations do not include detailed description regarding an ON/OFF control process and bit allocation amounts to the M-channel and the S channel. A conventional MS stereo method has both of monaural and stereo functions, and where a stereo process is not to be performed, the audio encoding apparatus turns off the MS stereo function and encodes a monaural-channel. On the other hand, where the stereo process is to be performed, the audio encoding apparatus switches on the MS stereo function and calculates sum components (Mch=Lch+Rch) and difference components (Sch=Lch−Rch) of spectrum signals of the L-channel and the R-channel, and then, allocates a predetermined number of bits to each of the calculated M-channel and S-channel and performs an audio encoding process for the M-channel and S channel.

An example of an encoded bit stream and an outline of the MS stereo method are described below with reference to FIGS. 18A to 18C and 19.

FIG. 18A is a view illustrating a format of an encoded bit stream, and indicates the MPEG2-AAC format (ADTS format) as an example. A frame (encoded bit stream) shown in FIG. 18A includes encoded audio signal data (encoded data or information data: Raw Data) for which processes such as compression and so forth have been performed, and as shown in FIG. 18B, the encoded data has audio encoding signal data of the L-channel (Lch) and the R-channel (Rch) Here, as shown in FIG. 18C, both of data included in the L-channel and the R-channel include a scale factor regarding a gain or a magnification of compression and decompression and spectral information regarding electric power upon reproduction for each frequency band.

Consequently, as shown in FIG. 18B, the audio encoding apparatus fixedly allocates one frame (one unit frame) to both of the L-channel and the R-channel.

An example of the number of bits of the encoded bit stream is described.

FIG. 19 is a diagram illustrating linear PCM (Pulse Coded Modulation) sampling at equal intervals of 48 kHz. The audio encoding apparatus samples the amplitude of an audio signal for 1 frame at each 1/48 second and outputs 1,024 sampling values obtained by the sampling. Then, it converts the sampling values into 16-bit values and outputs them. Here, where the bit rate (transmission rate) is 128 [kbps], the number of bits of the encoded bit stream is calculated using an expression given below. It is to be noted that [* ] and [/] represent multiplication and division, respectively.
128 [kbps]*1024 [values]/48 [kHz]=2730.6

Consequently, it can be recognized from above that the lowest necessary total number of bits in one frame is approximately 2730 bits.

Further, various encoding circuits and so forth conventionally proposed are described.

A circuit for varying the number of allocation bits for encoding is disclosed, for example, in Patent Document 1. An acoustic signal processing circuit disclosed in the Patent Document 1 generates a difference signal between channels and converts a reference signal and the difference signal into spectrum signals to encode them, and then, decides, upon encoding, the total number of bits to be allocated to encoding of the signals in accordance with the total power of the signals. Thereafter, when the spectrum signals are encoded, the sound signal processing circuit adaptively varies the digitization step and encoding allocation bit numbers within the allocated bit number.

Consequently, the encoding process can be performed with a high efficiency for an acoustic signal such as a stereo music signal without spoiling the clarity of the acoustic signal, and information compression of the acoustic signal can be performed.

Further, an encoding method of stereo sound is disclosed, for example, in Patent Document 2. The encoding method disclosed in the Patent Document 2 decides a correlation coefficient between left and right sound signals and varies a scale factor based on the correlation coefficient. Consequently, degradation of the quality of reproduced sound can be suppressed.

Further, a digital and stereo sound compression method disclosed in Patent Document 3 efficiently utilizes vector digitization and a high correlation between left and right channel signals to prevent degradation of the sound quality of a stereo sound signal and achieve a high efficiency in data compression.

Further, a method is disclosed, for example, in Patent Document 4 wherein a correlation between channels of a stereo sound signal is utilized to reduce the number of digitization bits.

A stereo sound signal encoding apparatus disclosed in the Patent Document 4 divides both of left and right channel sound signals individually into two frequency bands with respect to a specific frequency and produces a high band difference signal and a low band difference signal from high and low band signals of the channels. Then, the stereo sound signal encoding apparatus encodes one of the right channel high band signal and the left channel high band signal into a digital signal and encodes the high band difference signal into a digital signal, and encodes one of the right channel low band signal and the left channel low band signal into a digital signal and encodes the low band difference signal into a digital signal. Thereafter, the stereo sound signal encoding apparatus multiplexes the encoded digital signals.

Patent Document 1

Japanese Patent Laid-Open No. SHO 63-182700

Patent Document 2

Japanese Patent Laid-Open No. HEI 6-291669

Patent Document 3

Japanese Patent Laid-Open No. HEI 4-324718

Patent Document 4

Japanese Patent Laid-Open No. HEI 7-87033

However, where it becomes necessary to encode a great number of bits in order to improve the sound quality, the encoded data region allocated to one frame cannot be extended. The reason is that the bit rate such as 128 [kbps] is decided in advance by the recommendations or specifications, and further, a decoding apparatus cannot process an algorithm different from a decoding algorithm thereof. Accordingly, the number of bits for 1 frame for which an encoding process has been performed is fixed and limited by the sampling rate and the transmission rate.

This is described more particularly in connection with a case wherein, when a framing process is performed for an encoded M-channel signal and an encoded S-channel signal, a frame region (for example, a bit allocation amount) is insufficient and another case wherein the frame region is excessive.

FIGS. 20A to 20D are views illustrating allocation of a number of bits necessary for encoding where frame regions to be allocated to the M-channel and the S-channel are equal to each other.

A spectrum waveform shown in FIG. 20A is that of the M-channel and represents a spectrum wave form regarding a bit signal (time domain signal) for a period of time of 1 frame, and a spectrum band thereof is represented, for example, by a reference character D2. The audio encoding apparatus divides (fragmentizes) the spectrum waveform into a plurality of sub bands and samples the power of the spectrum waveform in each of the sub bands. Then, the audio encoding apparatus performs a PCM process for the powers of the sub bands and outputs bits obtained by adding the PCM sampling signals ranging over all of the subbands. Therefore, the number of bits of the encoded data of the M-channel is great, and the bits cannot be stored into the M-channel region corresponding to one half of 1 frame shown in FIG. 20B, and as a result, the M-channel becomes insufficient against the number of bits. In particular, only the PCM sampling signals ranging from a spectrum band D1 from within the spectrum band D2 shown in FIG. 20A can be placed into 1 frame. Accordingly, when the PCM sampling signals are decoded by the decoding apparatus, there is the possibility that the sound quality of the audio signal is degraded or the audio signal cannot be decoded.

On the other hand, a spectrum waveform shown in FIG. 20C represents that of the S channel, and is low in power when compared with the power of the spectrum wave form shown in FIG. 20A. Therefore, the number of bits obtained by the audio encoding apparatus multiplying, for the S channel, the PCM sampling signals by the number of sub bands is smaller than that shown in FIG. 20B. Therefore, the S-channel to which one half of 1 frame is allocated as shown in FIG. 20D only requires a smaller number of sampling signals.

Accordingly, a surplus of the number of bits occurs in the region allocated to the S-channel from within 1 frame shown in FIG. 20D. As described above, the bit amounts of the M-channel and S-channel are unequal, and if the numbers of bits to be allocated to the M-channel and the S-channel are set equal to each other, then this makes encoding and decoding inefficient.

Accordingly, the conventional technique has a subject in that the number of bits which can be inserted into a transmission frame from among the number of bits encoded by the encoding apparatus is limited by the sampling rate and the transmission rate decided in advance.

In addition, in the stereo type encoding apparatus and decoding apparatus proposed conventionally, upon decoding processing, one channel signal leaks to the other-channel signal to generate noise. In this regard, the encoding apparatus (or methods) disclosed in the Patent Documents 1 to 4 mentioned above cannot perform the stereo process when the correlation degree between the two channels is low and cannot therefore prevent appearance of noise arising from leakage of a channel signal.

### SUMMARY OF THE INVENTION

It is an object of the present invention to provide an audio encoding apparatus for stereo audio encoding an L-channel PCM signal and an R-channel PCM signal and a frame region allocation circuit for an audio encoding apparatus which can efficiently allocate encoded data of the L-channel and the R-channel without involving variation or modification to an existing frame format and can optimally perform MS stereo ON/OFF control and control of a bit allocation amount or a frame region for the inputted PCM signals and particularly can adjust the size of a frame region upon encoding without being limited by a sampling rate, a transmission rate and so forth.

In order to attain the object described above, according to an aspect of the present invention, there is provided an audio encoding apparatus which performs a stereo audio encoding process of an L-channel sampling signal and an R-channel sampling signal, comprising a correlation degree calculation section for calculating, based on the L-channel sampling signal and the R-channel sampling signal, a correlation degree between the L-channel sampling signal and the R-channel sampling signal, a decision section for deciding whether or not a stereo encoding process should be performed based on the correlation degree calculated by the correlation degree calculation section, an allocation section for allocating frame regions for individually storing a difference signal and a sum signal between the L-channel sampling signal and the R-channel sampling signal based on a result of the decision by the decision section, and audio encoding means for encoding the difference signal and the sum signal based on the frame regions allocated by the allocation section.

With the audio encoding apparatus, since an MS conversion (MS stereo conversion) process is performed, for example, for inputted PCM signals on the time base, the correlation degree (degree of correlation) between the L-channel and the R-channel can be decided, and consequently, the MS stereo on or off condition can be decided and bit allocations to the M-channel and the S-channel can be decided.

According to another aspect of the present invention, there is provided an audio encoding apparatus which performs a stereo audio encoding process of an L-channel sampling signal and an R-channel sampling signal, comprising a frequency conversion section for converting the L-channel sampling signal and the R-channel sampling signal into L-channel spectral data and R-channel spectral data of a frequency region, respectively, a second correlation degree calculation section for calculating a correlation degree between the L-channel spectral data and the R-channel spectral data based on the L-channel spectral data and the R-channel spectral data converted by the frequency conversion section, a decision section for deciding whether or not a stereo encoding process should be performed based on the correlation degree calculated by the second correlation degree calculation section, an allocation section for allocating frame regions for individually storing a difference signal and a sum signal between the L-channel sampling signal and the R-channel sampling signal based on a result of the decision by the decision section, and audio encoding means for encoding the difference signal and the sum signal based on the frame regions allocated by the allocation section.

With the audio encoding apparatus, where the numbers of bits to be allocated to the M-channel and the S-channel are unequal, the number of bits to be allocated to the M-channel can be increased, and efficient bit allocation can be achieved. This contributes to improvement in the sound quality.

According to a further aspect of the present invention, there is provided an audio encoding apparatus which performs a stereo audio encoding process of a plurality of sampling signals produced by sampling a sound source, comprising a correlation degree calculation section for calculating a correlation degree between the sampling signals based on the sampling signals, a decision section for deciding whether or not a stereo encoding process should be performed based on the correlation degree calculated by the correlation degree calculation section, an allocation section for allocating frame regions for individually storing a plurality of arithmetic operation result signals obtained by arithmetic operation between the sampling signals based on the result of the decision by the decision section, and audio encoding means for encoding the arithmetic operation result signals based on the frame regions allocated by the allocation section.

With the audio encoding apparatus, the bit allocation amount or the frame region can be utilized efficiently in accordance with an existing frame format, and the bit allocation amount or the frame region can be adjusted without being limited by the sampling rate, the transmission rate or the like.

Further, appropriate on/off control of the MS stereo process can be achieved, and noise generated between the L-channel signal and the R-channel signal can be usually prevented irrespective of the magnitude of the correlation degree and a high quality audio signal can be obtained.

Further, the present invention can be applied not only to the audio recording and reproduction system which uses a digital disk but also to the streaming download of audio data on the Internet, a digital broadcasting system and so forth, and the sound quality can be improved still more also in the systems just described.

Further, since dynamic range of the inputted PCM signal is smaller than a dynamic range obtained as a result of a cross-correlation value calculation or spectrum calculation, the accuracy regarding the power values of the signals can be easily assured, and this contributes very much to improvement in the quality and reliability of the audio signal. For example, also in a case wherein the amplitude of fluctuation of a cross-correlation coefficient, the power of a spectrum signal or the like is great, the accuracy regarding signal power calculation wherein a processor having a fixed point accuracy is used can be assured.

The correlation degree calculation section may be formed so as to calculate the correlation degrees based on a power of the difference signal and a power of the sum signal.

The allocation section may be formed so as to change the frame regions based on information regarding a surplus region of a frame for which the audio encoding process is performed, or may be formed so as to allocate frame regions in accordance with the correlation degree calculated by the correlation degree calculation section.

Further, the correlation degree calculation section maybe formed as described in paragraphs (i) to (iv) below:
(i) it is formed from a processor having a fixed point accuracy;
(ii) it calculates the correlation degree based on an area ratio between a waveform area of the difference signal and a waveform area of the sum signal;
(iii) it is formed so that, where the area ratio is low, the correlation degree calculation section increases the frame region for the sum signal and decreases the frame region for the difference signal, but where the area ratio is high, the correlation degree calculation section decreases an area difference between the frame area of the sum signal and the frame area of the difference signal; or
(iv) it is formed so as to calculate a cross-correlation coefficient between the L-channel sampling signal and the R-channel sampling signal and input the calculated cross-correlation coefficient as the correlation degree to the decision section.

Meanwhile, the second correlation degree calculation section may be formed so as to calculate the correlation degree based on a power of difference spectral data between the L-channel spectral data and the R-channel spectral data converted by the frequency conversion section and a power of sum spectral data between the L-channel spectral data and the R-channel spectral data.

The second correlation degree calculation section may be formed so as to calculate a cross-correlation coefficient between the L-channel spectral data and the R-channel spectral data and input the calculated cross-correlation coefficient as the correlation degree to the decision section.

Further, the allocation section may be formed so that, where it is decided by the decision section that the stereo encoding process should be performed, the allocation section allocates the frame regions in accordance with the correlation degree, but where it is decided by the decision section that the stereo encoding process should not be performed, the allocation section allocates the frame regions equally.

With the features described above, results of cross-correlation calculation and spectrum calculation have a great dynamic range, and if a processor (CPU: Central Processing Unit) having a fixed point accuracy is used, then it is difficult to assure the accuracy. However, since the dynamic range of the inputted PCM signals is smaller than that of a result of cross-correlation value calculation or spectrum calculation, it is easy to assure the accuracy. This contributes very much to the quality and reliability of the audio encoding apparatus.

The above and other objects, features and advantages of the present invention will become apparent from the following description and the appended claims, taken in conjunction with the accompanying drawings in which like parts or elements are denoted by like reference characters.

### BRIEF DESCRIPTION OF THE DRAWINGS

FIG. 1 is a block diagram showing an example of an audio recording and reproduction system according to a first embodiment of the present invention;

FIG. 2 is a block diagram of an audio encoding apparatus according to the first embodiment of the present invention;

FIG. 3 is a diagrammatic view illustrating a relationship between input signals to and output signals from an LR-MS conversion section according to the first embodiment of the present invention;

FIGS. 4A to 4D are waveform diagrams showing signal waveforms where the correlation degree between an L-channel PCM signal and an R-channel PCM signal is high;

FIGS. 5A to 5D are waveform diagrams showing signal waveforms where the correlation degree between the L-channel PCM signal and the R-channel PCM signal is low;

FIGS. 6A to 6C are views illustrating a bit allocation method to an M-channel and an S-channel according to the first embodiment of the present invention;

FIG. 7 is a view showing an example of a decision table according to the first embodiment of the present invention;

FIG. 8 is a view showing an example of a bit allocation table according to the first embodiment of the present invention;

FIG. 9 is a view showing a format of a bit stream of the AAC according to the first embodiment of the present invention;

FIG. 10 is a flow chart illustrating an allocation method of a number of bits according to the first embodiment of the present invention;

FIG. 11 is a flow chart illustrating a process of an area calculation section according to the first embodiment of the present invention;

FIG. 12 is a flow chart illustrating particulars of a process of an MS stereo on/off decision section according to the first embodiment of the present invention;

FIG. 13 is a flow chart illustrating a process of a bit allocation section according to the first embodiment of the present invention;

FIG. 14 is a flow chart illustrating particulars of a process of an MS stereo processing section according to the first embodiment of the present invention;

FIG. 15 is a block diagram of an audio encoding apparatus according to a modification to the first embodiment of the present invention;

FIG. 16 is a block diagram of an audio encoding apparatus according to a second embodiment of the present invention;

FIG. 17 is a block diagram of an audio encoding apparatus according to a modification to the second embodiment of the present invention;

FIG. 18A is a view illustrating a format of an encoded bit stream;

FIG. 18B is a view illustrating an example of audio encoding signal data of the L-channel and the R-channel;

FIG. 18C is a view illustrating an example of channel data of the L-channel and the R-channel;

FIG. 19 is a graph illustrating equal interval linear PCM sampling of 48 kHz; and

FIGS. 20A to 20D are views illustrating allocation of a number of bits necessary for encoding.

### DESCRIPTION OF THE PREFERRED EMBODIMENTS

In the following, embodiments of the present invention are described with reference to the drawings.

### A. Description of the First Embodiment of the Present Invention

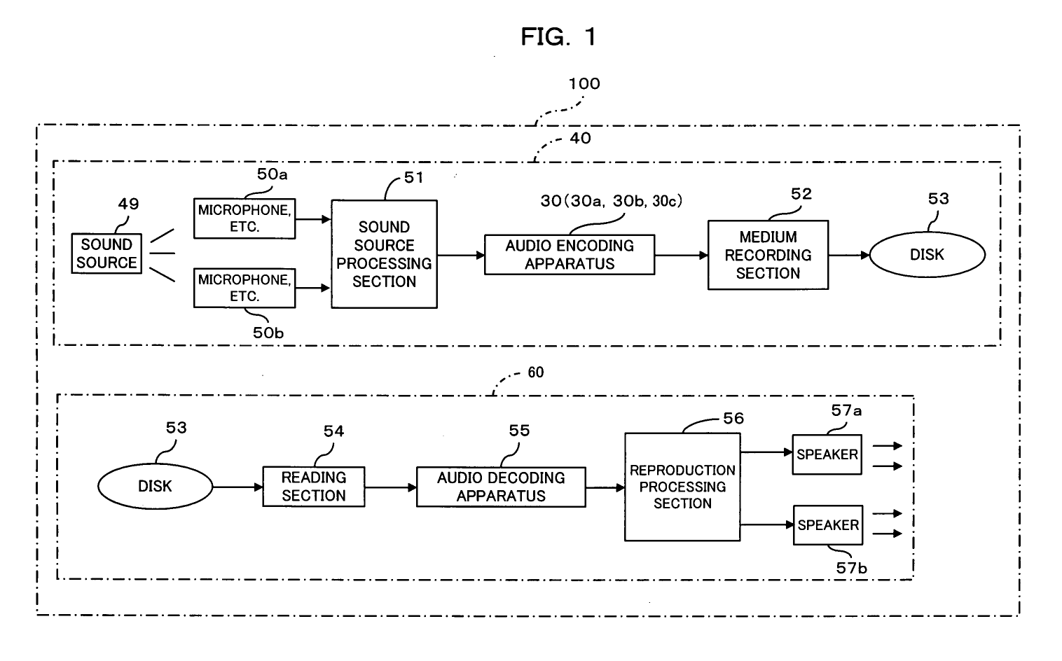

FIG. 1 is a block diagram showing an example of an audio recording and reproduction system according to a first embodiment of the present invention. The audio recording and reproduction system 100 shown in FIG. 1 acquires a sound source such as sound, voice, music or the like using stereo channels of an L-channel and an R-channel and performs an audio encoding process for the acquired sound source signals (sound source data) to record the signals on a digital disk, and further performs an audio decoding process for the digital disk to perform stereo reproduction of the recorded signals. The audio recording and reproduction system 100 includes an audio recording apparatus 40, a digital disk 53, and an audio reproduction apparatus 60.

1. Configuration of the Audio Recording and Reproduction System 100

The audio recording apparatus 40 audio encodes a sound source signal for outputting a sound source and records an audio encoded frame (or bit stream) on the digital disk 53. The audio recording apparatus 40 includes sound source inputting sections 50a and 50b, a sound source processing section 51, an audio encoding apparatus (audio encoding apparatus of the present invention) 30, a sound source 49 and a medium recording section 52.

The digital disk 53 is a mediumon which, for example, digital sound, digital images and so forth are recorded and may be, for example, a CD, a CD-R (CD-Recordable), a CD-RW (CD Rewritable) or a DVD.

The audio reproduction apparatus 60 stereo reproduces the digital disk 53 and includes a reading section 54, an audio decoding apparatus 55, a reproduction section (reproduction processing section) 56, and sound source outputting sections 57a and 57b.

2. Audio Recording Apparatus 40 The sound source inputting sections 50a and 50b convert the sound source 49 which outputs an audio signal into electric signals of an L-channel signal and an R-channel signal acquired by the L-channel and the R-channel and each includes a microphone, an amplifier and so forth. The sound source processing section 51 PCM samples the L-channel signal and the R-channel signal from the sound source inputting sections 50a and 50b to produce sampling sound source data of the L-channel and the R-channel, forms the produced sampling sound source data into frames of 1,024 sampling units, and outputs the frames.

The audio encoding apparatus 30 encodes a frame produced by the sound source processing section 51 and including sampling sound source data of the L-channel and the R-channel using, for example, the AAC to produce serial encoded data (stream data) and outputs the encoded data. It is to be noted that the audio encoding apparatus 30 of the present invention can use an audio encoding format such as the AAC and the MP3. audio encoding apparatus 30a, 30b and 30c are hereinafter described in connection with a modification, a second embodiment and a modification to the second embodiment.

The medium recording section 52 records stream data outputted from the audio encoding apparatus 30 on the digital disk 53.

Consequently, the sound source 49 is recorded in stereo by the sound source inputting sections 50a and 50b, and the recorded stereo sound source data are PCM sampled and then framed by the sound source processing section 51. Then, the framed PCM signals of the L-channel and the R-channel are converted into audio data by the audio encoding apparatus 30, and the thus converted audio data are recorded on the digital disk 53 by the medium recording section 52. Then, the digital disk 53 is sold or distributed.

3. Audio Reproduction Apparatus 60

The reading section 54 reads and outputs stream data recorded on the digital disk 53. The audio decoding apparatus 55 decodes stream data outputted from the reading section 54, which reads stream data of the digital disk 53, into a linear PCM signal, performs digital to analog conversion of the PCM signal to produce an analog audio signal, and outputs the analog audio signal. The audio decoding apparatus 55 can decode not only AAC encoded data but also data encoded using an audio encoding method such as, for example, the MP3.

The reproduction section 56 reproduces an analog signal from the audio decoding apparatus 55 and outputs resulting stereo signals. The sound source outputting sections 57a and 57b output the stereo signals from the reproduction section 56 as audio signals and each includes an amplifier, a speaker and so forth.

Consequently, stream data recorded on the digital disk 53 are read by the reading section 54, and the read stream data are decoded by the audio decoding apparatus 55. The decoded data are amplified by the reproduction section 56 and outputted as audio signals of a high sound quality from the speakers.

4. Configuration of the Audio Encoding Apparatus 30

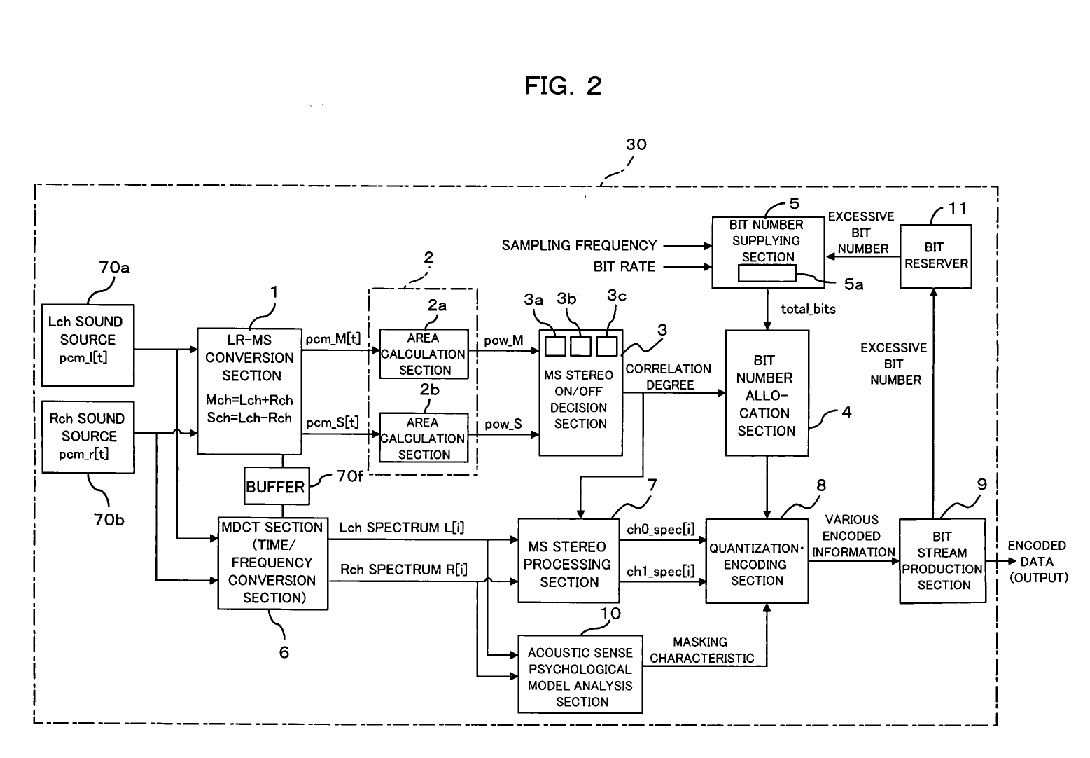

FIG. 2 is a block diagram of the audio encoding apparatus according to the first embodiment of the present invention. Referring to FIG. 2, the audio encoding apparatus 30 shown performs stereo audio encoding of an L-channel PCM signal (L-channel sampling signal) and an R-channel PCM signal (R-channel sampling signal). The audio encoding apparatus 30 includes an L-channel PCM signal production section (Lch sound source) 70a, an R-channel PCM signal production section (Rch sound source) 70b, an LR-MS conversion section 1, a power calculation section 2, an MS stereo on/off decision section (MS stereo ON/OFF decision section) 3, a bit number allocation section 4, a bit number supplying section 5, an MDCT processing section (Modified Discrete Cosine Transformation: time/frequency conversion section) 6, an MS stereo processing section 7, a quantization•encoding section (quantization and encoding section) 8, a bit stream production section 9, an acoustic sense psychological model analysis section 10, and a surplus bit number collection section (bit reserver) 11.

4-1. L-channel PCM Signal Production Section 70a and R-channel PCM Signal Production Section 70b

The L-channel PCM signal production section 70a and the R-channel PCM signal production section 70b PCM sample an audio signal from the sound source 49 and output resulting PCM signals of the L-channel and the R-channel to the audio encoding apparatus 30. The sound source signals for the 2 channels acquired by means of microphones and so forth are stored into a buffer 70f and represented in a time waveform for one frame, for example, shown in FIG. 19.

Sampling (the axis of ordinate) of the amplitude value and the sampling interval (axis of abscissa) of the PCM signals are described in more detail. The amplitude of each PCM signal is sampled (level sampled) such that the intervals in the direction of the axis of ordinate may be equal to each other, and the sampled amplitude values are converted into 16-bit values. Meanwhile, the axis of abscissa corresponds to one frame, and the PCM signal is sampled into, for example, 24 sample values at fixed sampling intervals. The sampling period (sampling width) is 1/48 second. Accordingly, the number of bits produced by the sampling is given by the product of the bit number of a level sampling value in one sample and the number of samples in one frame, and a number of bits equal to the product are transmitted in a transmission condition of a bit rate (transfer rate) of 128 kbps.

As well known in the art, where the quantization intervals are equal (linear sampling), for example, a sample value “200” is represented by the following expression (1):
200=128+64+8=2⁷+2⁶+2³ (1)

“200” is represented, using 8 bits as given by the following expression (2):
10000000+01000000+00001000=11001000 (2)

Accordingly, an electric signal waveform W of the one-frame length of each channel is represented by 8 (bits)×2,048=16,384 bits.

It is to be noted that the quantization interval can be set such that it is set rough where the sampling value is low but set dense where the sampling value is high. The audio encoding apparatus 30 may use PCM signals produced by an external apparatus (not shown) of the audio encoding apparatus 30 itself.

Consequently, the single sound source 49 is converted into electric signal waveforms by the microphones, amplifiers and so forth of the two systems for the L-channel and the R-channel, and the converted electric signal waveforms are subject to analog to digital conversion. The digital data of the two channels obtained by the conversion are linearly sampled, and resulting sampling values are outputted for each one-frame length.

4-2. LR-MS Conversion Section 1

The LR-MS conversion section 1 produces and outputs a sum signal of the L-channel PCM signal and the R-channel PCM signal and a difference signal between the L-channel PCM signal and the R-channel PCM signal. It is to be noted that the sum signal is also called addition signal, sum component or M (Middle) channel signal. The difference signal is also called difference component or S (Sides) channel signal.

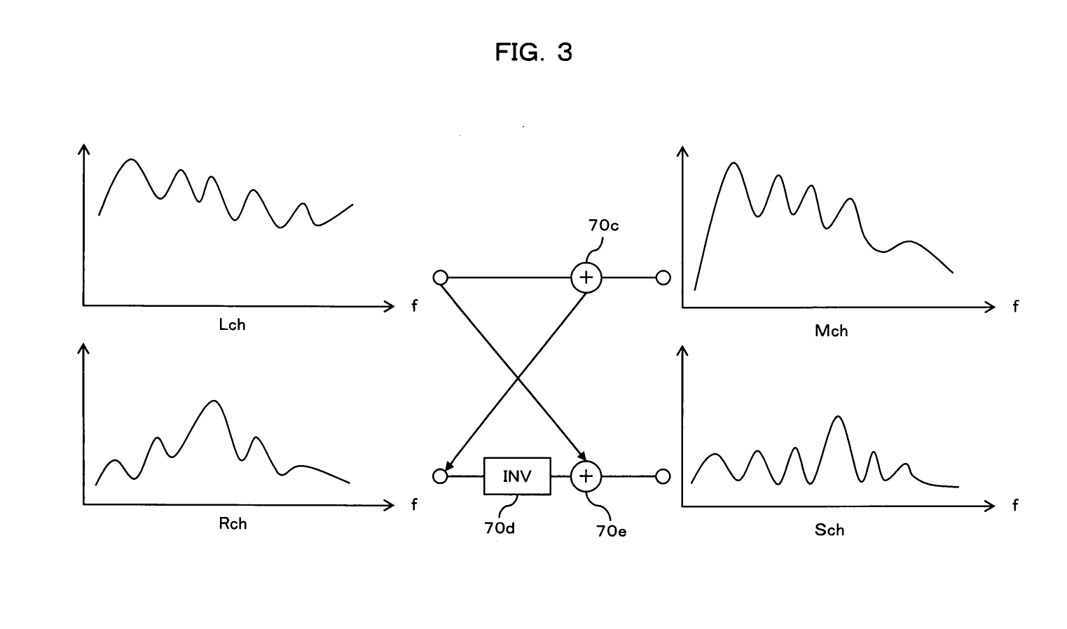

FIG. 3 is a view illustrating a relationship between input signals and output signals of the LR-MS conversion section 1 according to the first embodiment of the present invention. Referring to FIG. 3, the LR-MS conversion section 1 shown includes an addition section 70c for adding the L-channel PCM signal and the R-channel PCM signal, an inverter 70d for inverting the R-channel PCM signal between the positive and the negative, and another addition section 70e for adding the L-channel PCM signal and the R-channel PCM signal inverted by the inverter 70d.

More specifically, where PCM signals of the L-channel and the R-channel are represented by pcm_L(t) and pcm_R[t] (t represents the time) and PCM signals of the M-channel and the S-channel are represented by pcm_M[t] and pcm_S[t], respectively, the LR-MS conversion section 1 converts the L-channel PCM signal and the R-channel PCM signal inputted thereto into an M-channel PCM signal and an S-channel PCM signal represented by the following expressions (3) and (4), respectively:
pcm_{—}M[t]=pcm_{—}L[t]+pcm_{—}R[t] (3)
pcm_{—}S[t]=pcm_{—}L[t]−pcm_{—}R[t] (4)

It is to be noted that, where the number of times of sampling for one processing frame is represented by N (N represents a natural number. In the case of the AAC, N=2,048), then t represents the Nth sampling time in the one processing frame and t=0 to N-1. Further, pcm_S[t] may otherwise be defined by conversion subtraction of the L-channel signal from the R-channel signal.

After the LR-MS conversion section 1 fetches the PCM signals for one frame, an encoding process is started.

4-3. Power Calculation Section 2

The power calculation section 2 shown in FIG. 2 calculates and outputs the power of the S-channel signal and the power of the M-channel signal and includes an area calculation section 2a for calculating the power of the M-channel signal and another area calculation section 2b for calculating the power of the S-channel signal.

The area calculation sections 2a and 2b calculates the areas m_level and s_level of the M-channel PCM signal pcm_M[t] and the S-channel PCM signal pcm_S[t]. Each of the areas represents the area of a signal waveform and corresponds to the power of the PCM signal. Here, where the powers of the M-channel signal and the S-channel signal are represented by pow_M and pow_S, then the powers are represented by the following expressions (5) and (6), respectively:
pow_{—}M=Σ^{N-1}ₜ₌₀abs(pcm_{—}M[t]) (5)
pow_{—}S=Σ^{N-1}ₜ₌₀abs(pcm_{—}S[t]) (6)
where abs represents an absolute value, and Σ^{N-1}ₜ₌₀ represents the sum total of N sampling values at the sampling time t=0 to N-1. In particular, pow_M and pow_S are represented by the sum totals of the absolute values of the M-channel PCM signal pcm_M[t] and the S-channel PCM signal pcm_S[t], respectively.

It is to be noted that the powers pow_M and pow_S calculated in accordance with the expressions (5) and (6) relate to the frame at present (at the present point of time), and they are stored as pre_pow_M and pre_pow_S as powers calculated for the preceding frame in order to prepare for calculation when a next frame is inputted.

4-4. MS Stereo On/Off Decision Section 3

4-4-1. The MS stereo on/off decision section 3 decides whether or not an MS stereo process should be performed based on the M-channel PCM signal pcm_M[t] and the S-channel PCM signal pcm_S[t], respectively, and includes a correlation degree calculation section 3a, a comparison section 3b, and a decision table 3c.

The correlation degree calculation section 3a calculates, based on the L-channel PCM signal and the R-channel PCM signal, the correlation degree between the L-channel PCM signal and the R-channel PCM signal. More particularly, the correlation degree calculation section 3a calculates the correlation degree based on the power of the S-channel signal and the power of the M-channel signal.

In the following description, unless otherwise specified, the correlation degree represents a correlation (similarity) of signal waveforms. Further, the correlation degree is represented using a plurality of levels 0 to 5 or the like as hereinafter described.

4-4-2. Example of Calculation of the Correlation Degree Using the Area Ratio of Signal Waveforms

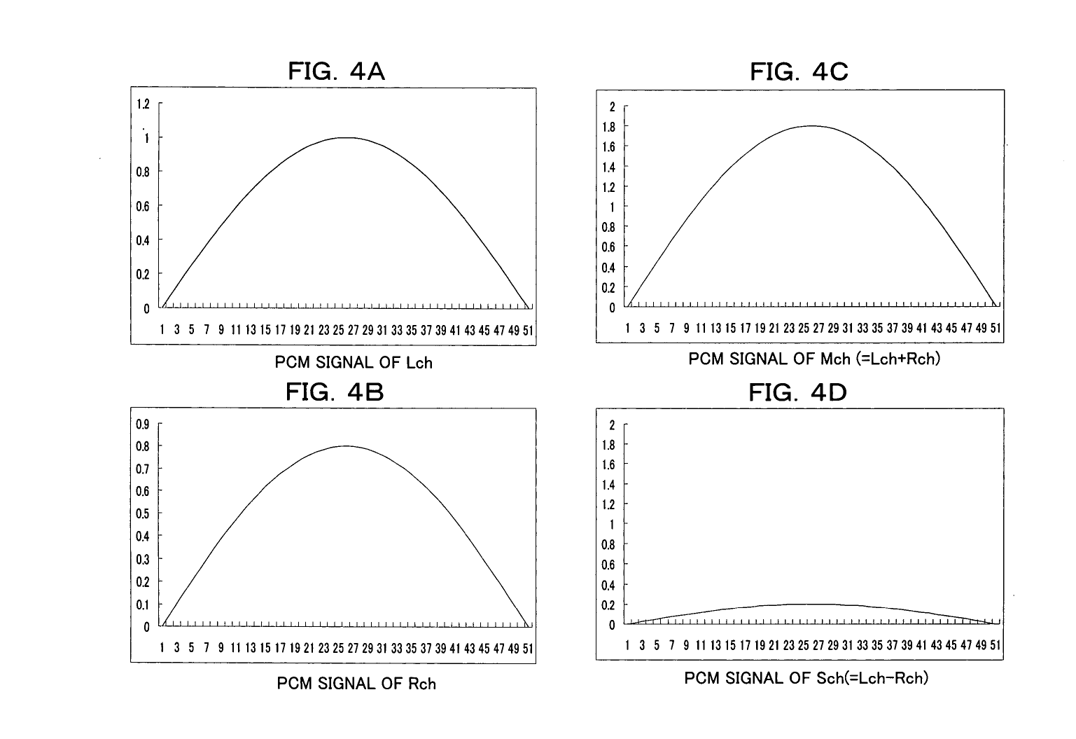

FIGS. 4A to 4D are views showing signal waveforms where the correlation degree of the L-channel PCM signal and the R-channel PCM signal is high. Particularly, FIGS. 4A and 4B show PCM input sound source waveforms where the correlation between the L-channel PCM signal and the R-channel PCM signal is high.

The M-channel PCM signal waveform shown in FIG. 4C is a waveform obtained by addition of the L-channel PCM signal waveform (FIG. 4A) and the R-channel PCM signal waveform(FIG. 4B). The S-channel PCM signal waveform shown in FIG. 4D is obtained by subtraction of the R-channel PCM signal waveform (FIG. 4B) from the L-channel PCM signal waveform (FIG. 4A).

Accordingly, if the PCM signals of the L-channel and the R-channel are used to perform conversion of Mch=Lch+Rch and Sch=Lch−Rch, then the waveform area of the M-channel signal becomes large while the waveform area of the S-channel signal become small. In short, the ratio of (area of S-channel PCM signal)/(area of M-channel PCM signal) has a low value. In this instance, the MS stereo on/off decision section 3 decides that the waveforms of the PCM signals of the L-channel and the R-channel are similar to each other.

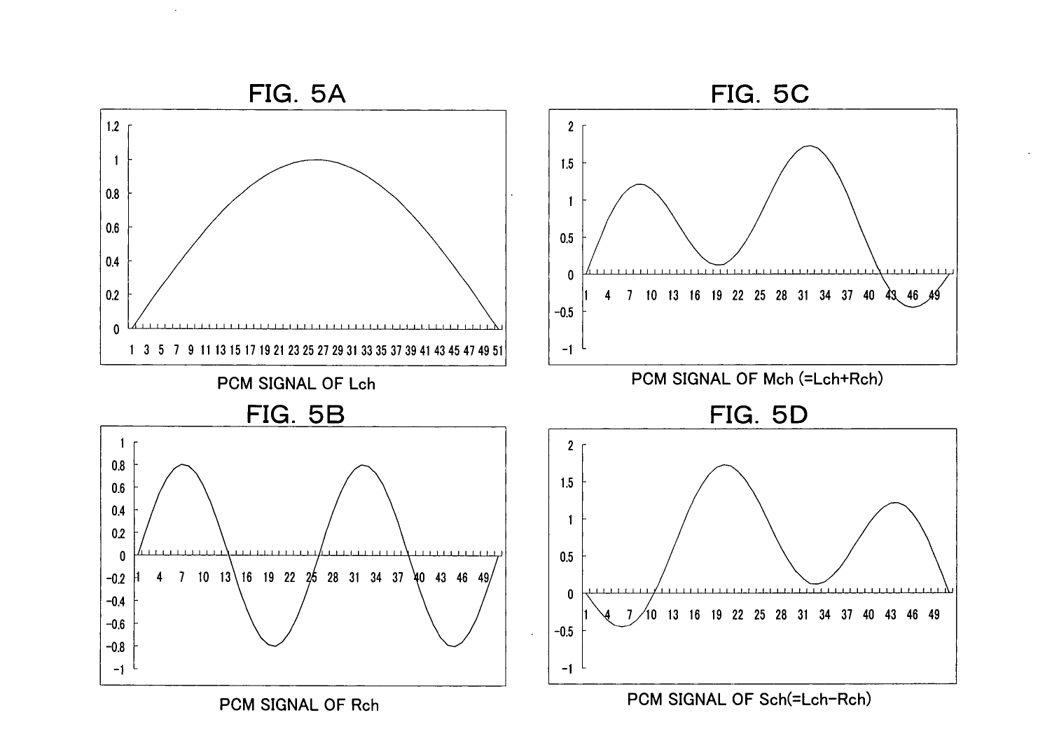

In contrast, FIGS. 5A to 5D are views showing signal waveforms where the correlation degree of the L-channel PCM signal and the R-channel PCM signal is low. Particularly, FIGS. 5A and 5B show PCM input sound source waveforms where the correlation between the L-channel PCM signal and the R-channel PCM signal is low. Here, if a difference signal between the PCM signals of the L-channel and the R-channel is calculated, then since the area of the S-channel PCM signal shown in FIG. 5D becomes great, the ratio of (area of S-channel PCM signal)/(area of M-channel PCM signal) has a high value. In this instance, the MS stereo on/off decision section 3 decides that the M-channel PCM signal and the S-channel PCM signal are similar to each other but the waveforms of the PCM signals of the L-channel and the R-channel are not similar to each other.

Accordingly, the correlation degree calculation section 3a arithmetically operates the correlation degree based on the area ratio between the waveform area of the S-channel signal and the waveform area of the M-channel signal.

In other words, the degree of correlation between the signals of the L-channel and the R-channel can be decided and the MS stereo on/off control can be discriminated by examining the ratio between the area of the S-channel PCM signal and the area of the M-channel PCM signal from the waveforms of the input PCM signals.

It is to be noted that the function of the correlation degree calculation section 3a can be implemented by a ROM (Read Only memory) and a RAM (Random Access Memory) as well as a processor of a fixed point accuracy.

Generally, in calculation wherein a correlation degree, a cross-correlation coefficient or a spectrum is used, since the variation width (dynamic range) of power variation of the cross-correlation coefficient, spectrum or the like is very great, if the audio encoding apparatus 30 performs calculation using a processor of a fixed point accuracy, then it is difficult to assure the accuracy for the power value of the signal.

In contrast, in the audio encoding apparatus 30 of the present invention, since the dynamic range of each of the inputted PCM signals is narrow when compared with the dynamic range of a result of calculation of the cross-correlation value or the spectrum, it is easy to assure the accuracy for the power value of the signal. This contributes to improvement in the quality and the reliability of the audio signal by the audio encoding apparatus 30.

4-4-3. Bit Distribution to the M-Channel and the S Channel

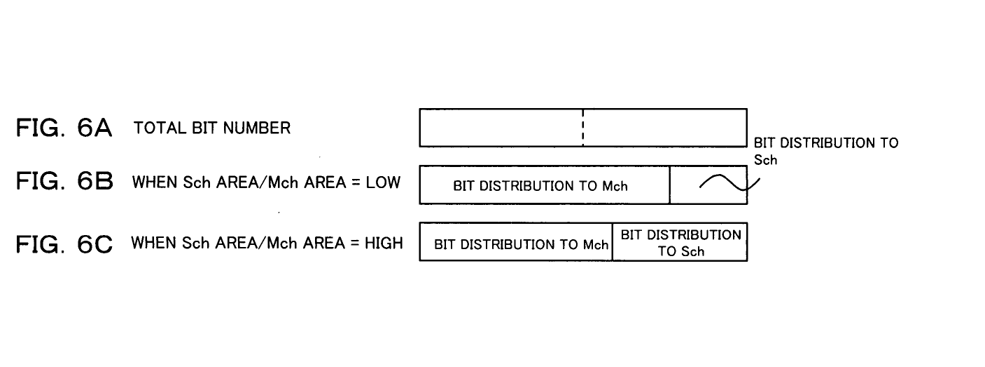

FIGS. 6A to 6C are views illustrating a bit distribution method to the M-channel and the S-channel according to the first embodiment of the present invention. A frame write region shown in FIG. 6A is a region corresponding to the total bit number. The bit number allocation section 4 determines, upon encoding processing, the number of bits necessary for the encoding processing in response to set values for the sampling rate and the bit rate.

Then, in the MS stereo off state, the bit number allocation section 4 allocates the bit number so that the bit numbers to the L-channel and the R-channel may be equal to each other as seen in FIG. 6A. On the other hand, in the MS stereo on state, the bit number allocation section 4 allocates the bit number to the M-channel and the S-channel based on the correlation degree between the signals of the L-channel and the R-channel.

More particularly, in a frame shown in FIG. 6B, where the area ratio of (area of S channel)/(area of M channel) is low, the bit number allocation section 4 increases the number of bits to be allocated to the M-channel and decreases the number of bits to be allocated to the S channel. Further, in another frame shown in FIG. 6C, where the area ratio of (area of Sch)/(area of Mch) is high, the bit number allocation section 4 allocates the bit number so that the difference between the allocated bit number to the M-channel and the allocated bit number to the S-channel may decrease. It is to be noted that the allocated bit number to the M-channel does not become smaller than the allocated bit number to the S channel.

Accordingly, where the bit numbers of the M-channel and the S-channel are not equal to each other as seen in FIGS. 4C and 4D, the audio encoding apparatus 30 can increase the bit number to the M channel. Consequently, efficient bit allocation can be achieved, and this contributes to improvement in the sound quality.

In this manner, the bit number allocation section 4 allocates the frame region in response to the correlation degree calculated by the correlation degree calculation section 3a.

Further, the audio encoding apparatus 30 of the present invention determines the bit numbers to be allocated to the M-channel and the S-channel in response to the area ratio of the M-channel and the S-channel in this manner. Consequently, efficiency processing can be achieved.

4-4-4. Comparison section 3b and decision table 3c The comparison section 3b decides on/off of the MS stereo process based on the correlation degree calculation section 3a and the decision table 3c.

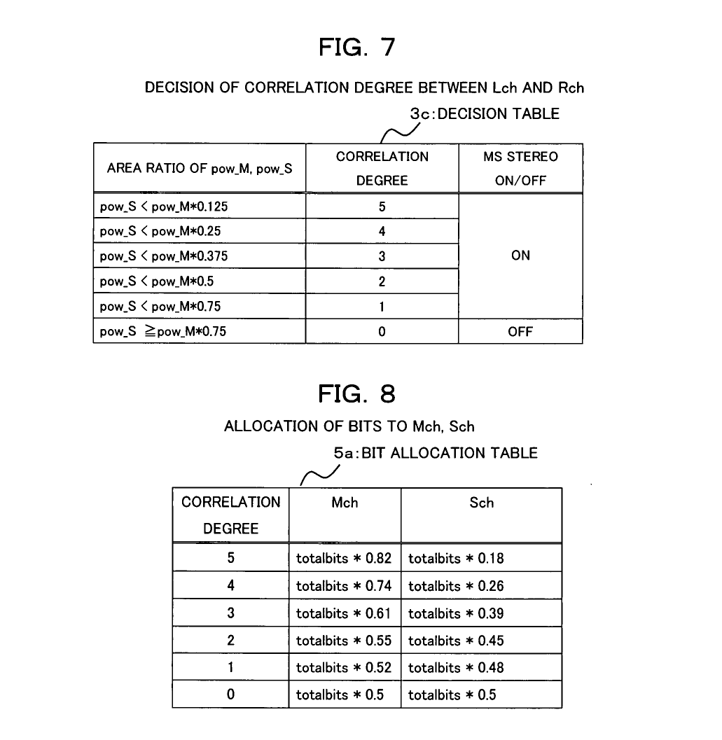

FIG. 7 is a view showing an example of the decision table 3c according to the first embodiment of the present invention. The decision table 3c shown in FIG. 7 represents the correlation degree between the inputted PCM signals of the L-channel and the R-channel and stores the ratios of the power values of pow_M and pow_S in six different classified stages.

“pow_S<pow_M*0.125” in the column of “Area radio between pow_M and pow_S” signifies that the area ratio (pow_S/pow_M) is, for example, lower than 0.125. The value of the ratio such as 0.125 or 0.25 functions also as a coefficient (or a threshold value). Further, the column of “Correlation degree” signifies a value (correlation degree value) allocated in advance in response to the area ratio. The column of “MS stereo on/off” represents on/off of the MS stereo process with regard to the “Area ratio between pow_M and pow_S” and the “Correlation degree”. Further, the decision table 3c stores the correlation degree such that, as the value of the correlation degree increases, the correlation between the L-channel and the R-channel of the input PCM signals increases.

Accordingly, the decision table 3c stores the “Area ratio between pow_M and pow_S”, “Correlation degree” and “MS stereo on/off” in a mutually associated relationship.

Further, the MS stereo on/off decision section 3 decides whether or not the stereo encoding process should be carried out based on the correlation degree calculated by the correlation degree calculation section 3a.

It is to be noted that the criterion for decision in magnitude of the area ratio is decided, for example, by a simulation, a test or the like, and various values can be used as the reference value for the area ratio. Also for the correlation degree value, various values can be used. Further, the function of the decision table 3c is implemented, for example, by means of a RAM or a ROM.

Consequently, where the area ratio is, for example, lower than 0.75, the comparison section 3b refers to the decision table 3c and decides that the MS stereo process should be carried out. On the other hand, for example, where the area ratio is equal to or higher than 0.75, the comparison section 3b refers to the decision table 3c and decides that the correlation degree is 0 and thus decides that the MS stereo process should not be carried out.

In this manner, according to the audio encoding apparatus 30 of the present invention, the on/off control of the MS stereo process can be implemented by a simple circuit configuration through calculation of the waveform area ratio. Conventionally, in order to calculate a waveform area ratio, it is necessary to precisely process a large number of sampling bits, and this involves a very great amount of arithmetic operation including addition and subtraction and a high load is applied to the processor. According to the audio encoding apparatus 30 of the present invention, however, since the correlation degree is defined with a waveform are a ratio, the load to the processor is moderated significantly.

4-4-5. Frame Region Allocation Circuit (3a, 3b, 4)

The LR-MS conversion section 1, MS stereo on/off decision section 3 and bit number allocation section 4 cooperatively function as a frame region allocation circuit (3a, 3b, 4) of the audio encoding apparatus 30. In particular, the frame region allocation circuit (3a, 3b, 4) includes a correlation degree calculation section 3a for calculating, based on the L-channel PCM signal and the R-channel PCM signal, the correlation degree between the L-channel PCM signal and the R-channel PCM signal, an MS stereo on/off decision section 3 for deciding, based on the correlation degree calculated by the correlation degree calculation section 3a, whether or not the stereo encoding process should be carried out, and an allocation section 4 for allocating, based on a result of the decision by the MS stereo on/off decision section 3, frame regions for storing a difference signal and a sum signal between the L-channel PCM signal and the R-channel PCM signal.

Thus, the audio encoding apparatus 30 of the present invention can achieve expansion of functions by connecting the frame region allocation circuit (3a, 3b, 4) to the inside or the outside of an existing audio encoding apparatus (not shown in the drawings).

4-5. Bit Number Allocation Section 4

The bit number allocation section 4 allocates, based on the result of decision by the MS stereo on/off decision section 3, frame regions for storing the S-channel signal and the M-channel signal of the L-channel PCM signal and the R-channel PCM signal. More particularly, the bit number allocation section 4 determines the numbers of bits to be allocated (bit allocation) to the M-channel PCM signal and the S-channel PCM signal in response to the correlation value (correlation degree value) outputted from the MS stereo on/off decision section 3. The bit number allocation section 4 inputs the determined bit allocation to the quantization•encoding section 8.

4-6. Bit Number Supplying Section 5 and Surplus Bit Number Collection Section 11

The bit number supplying section 5 allocates a total bit number total_bits per one frame determined from the sampling frequency (sampling rate) and the bit rate to the M-channel PCM signal and the S-channel PCM signal, and includes a bit distribution table 5a.

FIG. 8 is a view showing an example of the bit distribution table 5a according to the first embodiment of the present invention. Referring to FIG. 8, the bit distribution table 5a shown is provided to allocate a bit write region (total bit number) per one frame to the M-channel and the S-channel in accordance with one of the six stages of the correlation degree. For example, where the “Correlation degree” is 5, the bit number supplying section 5 allocates 82% and 18% of the total bit number to the M-channel and the S channel, respectively. Accordingly, as the correlation degree value increases, the bit distribution to the M-channel increases, but as the correlation degree value decreases, the bit distribution to the M-channel decreases.

The surplus bit number collection section 11 collects surplus bit number information (information regarding a surplus region) appearing in a write region of a frame outputted from the bit stream production section 9 hereinafter described. Then, the bit number allocation section 4 changes the frame region based on the surplus bit number information of the audio encoded frame.

Consequently, the bit number supplying section 5 produces a frame format such as the frame length defined by the system specifications with certainty based on the sampling frequency, the bit rate and the surplus bit number information supplied thereto from the surplus bit number collection section 11, and besides performs writing into the surplus region thereby to produce an efficient frame.

It is to be noted that various values can be used as the values stored in the bit distribution table 5a. Further, the function of the bit distribution table 5a is implemented, for example, by a RAM or a ROM.

4-7. MDCT Processing Section 6

The MDCT processing section 6 performs modified discrete cosine transform for the inputted L-channel PCM signal pcm_L[t] and R-channel PCM signal pcm_R[t] to transform time components of the PCM signals of the L-channel and the R-channel into frequency components. The modified discrete cosine transform is a discrete (discontinuous) process of the number of sub bands.

The MDCT processing section 6 produces and outputs an L-channel spectrum L[i] and an R-channel spectrum R[i] representative of discrete spectrum sampling values of the frequency domain transformed by the modified discrete cosine transform.

4-8. MS Stereo Processing Section 7

The MS stereo processing section 7 performs an MS stereo process for the spectrum signals of the L-channel and the R-channel frequency transformed by the MDCT processing section 6 in response to the correlation degree outputted from the MS stereo on/off decision section 3. In the following, particular processes of the MS stereo processing section 7 in the MS stereo on state and the MS stereo off state are described.

4-8-1. Process in the MS Stereo on State

The MS stereo processing section 7 establishes an MS stereo on state when the correlation degree has one of the values 1 to 5 (refer to FIG. 7) and calculates a sum component (M-channel signal) and a difference component (S-channel signal) of frequency components of the L-channel and the R-channel. Where the sum component and the difference component are represented as M-channel signal ch0 and S-channel signal ch1, respectively, and the M-channel spectrum signal and the S-channel spectrum signal representative of the frequency components of the M-channel signal ch0 and the S-channel signal ch1 are represented by ch0_spec[i] and ch1_spec[i], respectively, the MS stereo processing section 7 performs, in the MS stereo on state, arithmetic operation represented by the following expressions (7) and (8):
ch0_{—}spec[i]=(L[i]+R[i])/2 (7)
ch1_{—}spec[i]=(L[i]−R[i])/2 (8)
where i=0 to K-1, and K is a natural number representative of the number of points (frequency resolution) in the MDCT process.

Further, the MS stereo processing section 7 stores the M-channel signal ch0 and the S-channel signal ch1 into the buffer 70f with use_bits0 and use_bits1 added thereto.

It is to be noted that the MS stereo processing section 7 inputs gain information to the quantization•encoding section 8 in addition to the signals ch0_spec[i] and ch1_spec[i] of the frequency components. The gain information is information applied to each of frequency bands obtained by dividing, for example, each of 1,024 sub bands each obtained by division into 2 to 4 sub bands. The gain information is used in the encoding process of the quantization•encoding section 8.

4-8-2. Process in the MS Stereo off State

On the other hand, where the correlation degree is 0 (refer to FIG. 7), the MS stereo processing section 7 establishes an MS stereo off state and maintains both of the M-channel signal ch0 and the S-channel signal ch1 representative of the sum component and the difference component as the signals of the L-channel and the R-channel, respectively. In other words, in the MS stereo off state, the MS stereo processing section 7 performs arithmetic operation represented by the following expressions (9) and (10):
ch0_spec[i]=L[i] (9)
ch1_spec[i]=R[i] (10)
4-9. Quantization•Encoding Section 8

The quantization•encoding section 8 functions as audio encoding means for encoding the S-channel signal and the M-channel signal based on the frame regions allocated by the bit number allocation section 4. More particularly, the quantization•encoding section 8 performs quantization and encoding for each parameter for the M-channel spectrum signal ch0_spec[i] and the S-channel spectrum signal ch1_spec[i] outputted from the MS stereo processing section 7 based on a masking characteristic calculated by the acoustic sense psychological model analysis section 10 hereinafter described and outputs resulting various kinds of encoded information.

More specifically, the quantization process of the quantization•encoding section 8 raises the M-channel spectrum signal ch0_spec[i] and the S-channel spectrum signal ch1_spec[i] from the MS stereo processing section 7 to the ¾th power to distort them nonlinearly. Then, the encoding process of the quantization•encoding section 8 encodes the spectrum signals ch0_spec[i] and ch1_spec[i] raised to the ¾th power by Huffman encoding using the gain information inputted from the MS stereo processing section 7.

Consequently, the M-channel spectrum signal ch0_spec[i] and the S-channel spectrum signal ch1_spec[i] outputted from the MS stereo processing section 7 are quantized and encoded for each parameter based on the masking characteristic calculated by the acoustic sense psychological model analysis section 10 by the quantization•encoding section 8.

4-10. Acoustic Sense Psychological Model Analysis Section 10

The acoustic sense psychological model analysis section 10 analyzes and decides, for each of the spectrum signals of the L-channel spectrum L[i] and the R-channel spectrum R[i] converted into frequency components by the MDCT processing section 6, a quantization error (masking characteristic) acceptable, for example, to each of the 1,024 divisional sub bands (frequency bands) based on an acoustic sense characteristic such as an audio spectrum range. It is to be noted that, for the masking characteristic, a masking characteristic standardized, for example, as an encoding algorithm is used.

Consequently, efficient compression conforming to the audio sense characteristic wherein sound which cannot be heard is deleted and the data amount is decreased by the masking effect can be achieved.

4-11. Bit Stream Production Section 9

The bit stream production section 9 produces a bit stream conforming to the standards such as the AAC or the MP3 using the parameters quantized and encoded by the quantization•encoding section 8 and outputs the produced bit stream as encoded data.

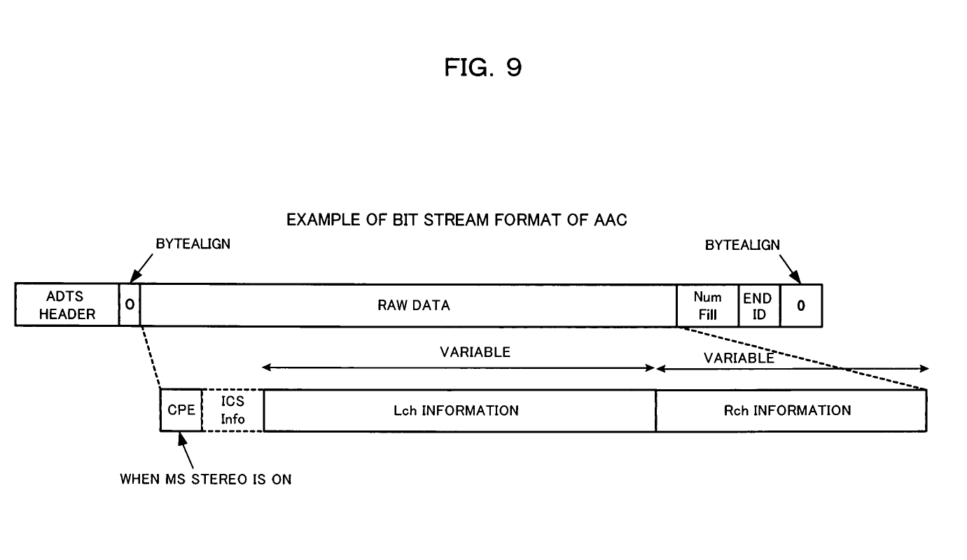

FIG. 9 is a view showing a format of a bit stream of the AAC according to the first embodiment of the present invention. Referring to FIG. 9, the bit stream shown corresponds to one frame and has regions for an ADTS (Audio Data Transport Stream) header, a byte align (Byte Align), encoded data (Raw Data), a “0” insertion (Num fill) and an end ID (End Identification).

The ADTS header is a region representative of the top of one frame and includes a synchronization word and information necessary for a decoding process by the audio reproduction apparatus 60 (refer to FIG. 1). More particularly, the sampling frequency, channel number, frame length, stereo/monaural type and AAC profiles (LL, SSR, main and so forth) are written in the ADTS header. The Byte Align allows the audio reproduction apparatus 60 to process data included in a received frame in a unit of 1 byte. For example, when the bit stream production section 9 inserts information bits into one frame shown in FIG. 6B, if 4 excessive its appear, then “0” is placed into the excessive bits thereby to allow the audio reproduction apparatus 60 to process the received frame in a unit of 1 byte.

The encoded data includes variable length audio data of the L-channel and the R-channel and has a region (CPE) for identifying whether or not the encoded data are MS stereo processed data and another region (ICS Info) for storing information regarding the length of a window used upon analysis of audio data by the audio reproduction apparatus 60, the number of subbands (band dividing number: for example, 1,024) and so forth. The “0” insertion part following the encoded data has dummy bits inserted therein for adjusting the bit rate. More particularly, where the audio data is encoded with a smaller number of bits, dummy bits are inserted in the “0” insertion section in order to adjust the bit rate of the audio data to an average bit rate (for example, 128 kHz). The end ID indicates the end position of the one frame.

Accordingly, the audio encoding apparatus 30 of the present invention can allocate encoded data of the L-channel and the R-channel efficiently without changing or modifying an existing format.

5. Description of Operation

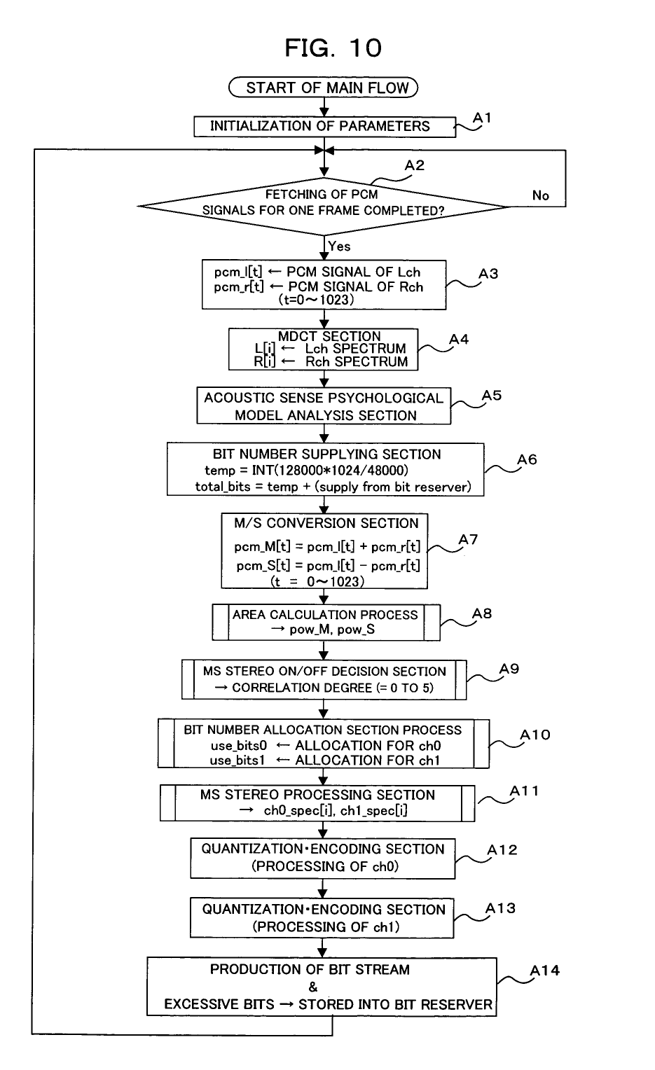

A bit number allocation method of the audio encoding apparatus 30 according to the first embodiment of the present invention having the configuration described above is described in detail below with reference to FIGS. 10 to 13.

5-1. Main Flow

FIG. 10 is a flow chart illustrating a bit number allocation method according to the first embodiment of the present invention. The following description proceeds under the assumption that the sampling rate is 48 [kHz] and the bit rate is 128 [kbps].

The audio encoding apparatus 30 of the present invention initializes various parameters first (step A1) and then supervises to detect whether or not fetching of PCM signals for one frame (1,024 samples) is completed (step A2). Then, while the fetching remains not completed, the processing follows a No route to continue the supervision. Then, after the fetching is completed, the processing follows a Yes route and starts an encoding process.

The LR-MS conversion section 1 stores the PCM signals of the L-channel and the R-channel by 1,024 samples (t=0 to 1,023) written in the frame (hereinafter referred to as current frame) upon completion of the fetching into pcm_L[t] and pcm_R[t], respectively (step A3). Then, the MDCT processing section 6 stores spectrum sampling values of the PCM signals of the L-channel and the R-channel into the L-channel spectrum L[i] and the R-channel spectrum R[i], respectively (step A4).

Further, the acoustic sense psychological model analysis section 10 analyzes and determines a masking characteristic acceptable to each of 1,024 divisional sub bands for each of the spectrum sampling values of the L-channel spectrum L[i] and the R-channel spectrum R[i] (step A5).

Then, at step A6, the bit number supplying section 5 calculates the bit rate 128 [kbps]×1,024 [sub band division number 1,024]/sampling rate 48 [kHz] and temporarily (temp) acquires 2,730 [bits] from the integer part (INTeger) of 2,730.6 [bits] obtained by the calculation. Consequently, it is determined that the least number of bits necessary for 1 frame is approximately 2,730 [bits]. Further, the bit number supplying section 5 adds a surplus bit number received from the surplus bit number collection section 11 to the 2,730 [bits] thereby to obtain a total bit number total_bits (step A6).

Then, the LR-MS conversion section 1 uses the expressions (3) and (4) to obtain PCM signals pcm_M[t] and pcm_S [t] of the M-channel and the S-channel (step A7). Then, the area calculation sections 2a and 2b use the expressions (5) and (6) to acquire powers pow_M and power_S of the M-channel signal and the S-channel signal (step A8), respectively.

Thereafter, the bit number allocation section 4 decides a correlation degree (step A9) and stores an M-channel signal ch0 and an S-channel signal ch1 representative of a sum component and a difference component with use_bits0 and use_bits1 added thereto, respectively, into the buffer 70f (step A10).

Then, the MS stereo processing section 7 acquires the M-channel spectrum signal ch0_spec[i] and the S-channel spectrum signal ch1_sepc[i] representative of frequency components of the M-channel signal ch0 and the S-channel signal ch1, respectively (step A11).

Further, the quantization•encoding section 8 performs quantization and encoding for the M-channel spectrum signal ch0_spec[i] (step A12) and performs quantization and encoding also for the S-channel spectrum signal ch1_spec[i] (step A13). Furthermore, the bit stream production section 9 produces a bit stream from the quantized and encoded parameters and stores a excessive bit number into the excessive bit number collection section 11 (step S14). Thereafter, the processing returns to step A2 so that the processes at the steps beginning with step A2 are repeated.

In this manner, the audio encoding apparatus 30 of the present invention converts PCM signals of the L-channel and the R-channel inputted in stereo into signals of the M-channel and the S-channel on the time base in accordance with the AAC, MP3 or the like and then calculates the powers of the M-channel and the S-channel to decide a correlation degree between the PCM signals of the L-channel and the R-channel. Consequently, the audio encoding apparatus 30 can perform an MS stereo on/off discrimination and decide bit allocations to the M-channel and the S channel, and therefore can allocate bits efficiently to the M channel. This contributes to improvement of the sound quality of the audio encoding apparatus 30.

5-2. Process of the Area Calculation Sections 2a and 2b (Power Calculation Section 2)

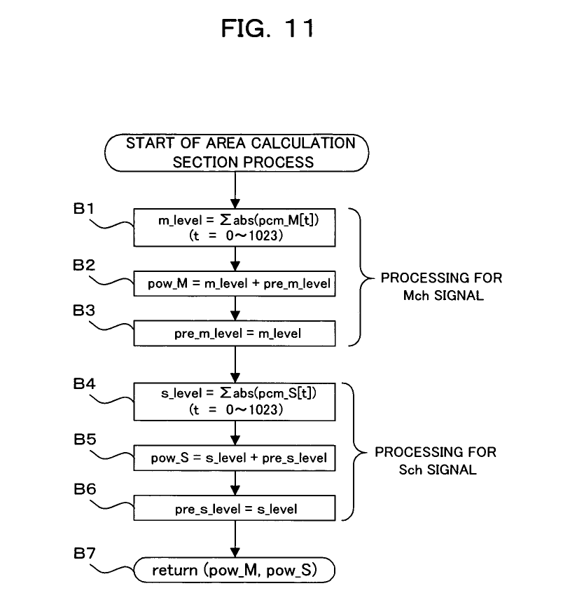

FIG. 11 is a flow chart illustrating a process of the area calculation sections 2a and 2b according to the first embodiment of the present invention and illustrates particulars of the process at step A8 of the flow chart shown in FIG. 10. The former half of the flow chart shown in FIG. 11 relates to the M-channel PCM signal, and the latter half of the flow chart relates to the S-channel PCM signal. For calculation of the areas, each of the PCM signals is required by two frames (2,048 samples).

As the process in the former half, the area calculation section 2a calculates the area m_level with regard to the current frame of the M-channel PCM signal in accordance with Σ^{N-1}ₜ₌₀abs(pcm_M[t]) given in the expression (5). More particularly, the area calculation section 2a adds absolute values of the 1,024 sampling values to obtain the current frame area m_level (step B1). Then, the area calculation section 2a adds the area m_level regarding the current frame of the M-channel PCM signal and the area pre_m_level regarding the preceding frame of the M-channel PCM signal to calculate the power pow_M of the M-channel signal (step B2). Then, the area calculation section 2a stores the area m_level regarding the current frame of the M-channel PCM signal as the area pre_m_level of the preceding frame in order to prepare for the area calculation for the succeeding frame (step B3).

Then, as the process in the latter half, the area calculation section 2b calculates the area S_level regarding the current frame of the S-channel PCM signal using the expression (6) (step B4), and adds the areas_level regarding the current frame and the area pre_s_level regarding the preceding frame to calculate the power pow_S of the S-channel signal (step B5). Then, the area calculation section 2b stores the area s_level regarding the current frame of the M-channel PCM signal as the area pre_s_level of the preceding frame (step B6).

Then, both of the area calculation sections 2a and 2b input the power pow_M of the M-channel signal and the power pow_S of the S-channel signal to the MS stereo on/off decision section 3 (step B7) Consequently, the MS stereo on/off decision section 3 decides whether or not the MS stereo process should be carried out.

In this manner, the area calculation sections 2a and 2b can calculate the processing amount for area calculation substantially by a processing amount for one frame. It is to be noted that both of the areas pre_m_level and pre_s_level are cleared to zero upon the parameter initialization (step A1) of FIG. 10.

5-3. Process of the MS Stereo On/Off Decision Section 3

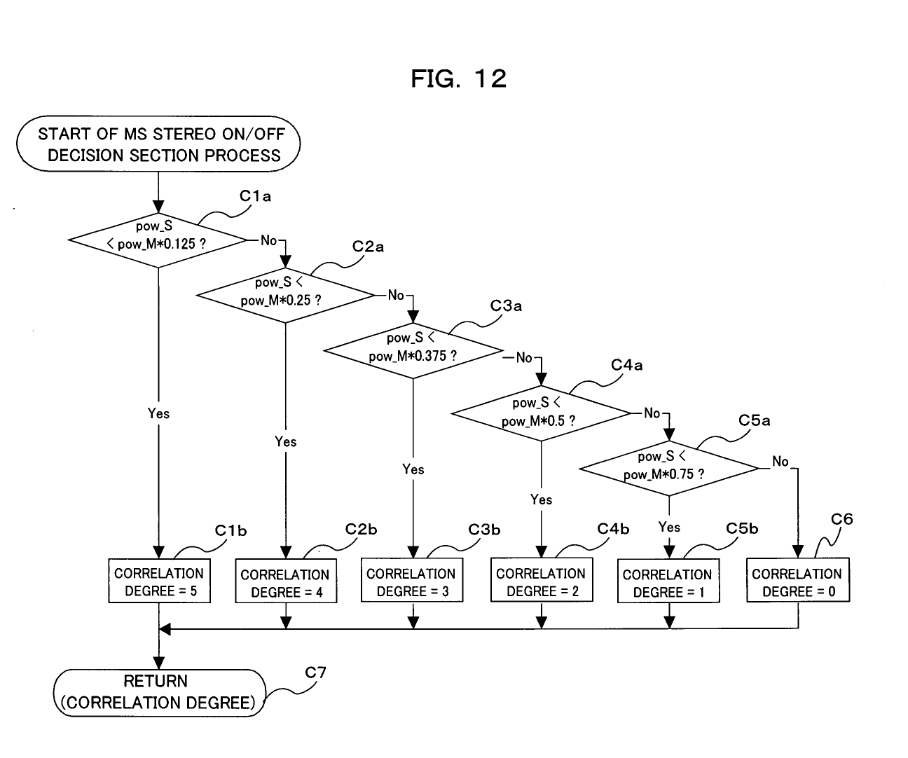

FIG. 12 is a flow chart illustrating particulars of the process of the MS stereo on/off decision section 3 according to the first embodiment of the present invention. Referring to FIG. 12, the MS stereo on/off decision section 3 decides whether or not the area ratio (pow_S/pow_M) is lower than a first coefficient (for example, 0.125 [refer to FIG. 7]) (step C1a). If the area ratio is lower than the first coefficient, then the processing follows a Yes route and the MS stereo on/off decision section 3 decides that the correlation degree is 5 (step C1b). On the other hand, if the area ratio is equal to or higher than the first coefficient, then the processing follows a No route and the MS stereo on/off decision section 3 compares the area ratio and a second coefficient 0.25 with each other to decide a relationship in magnitude between them (step C2a). If the area ratio is lower than the second coefficient, then the processing follows a Yes route and the MS stereo on/off decision section 3 decides that the correlation degree is 4 (step C2b). On the other hand, if the area ratio is equal to or higher than the second coefficient, then the processing follows a No route and the MS stereo on/off decision section 3 compares the area ratio and a third coefficient with each other at step C3a. Similarly, the MS stereo on/off decision section 3 successively compares the area ratio with another coefficient (steps C4a and C5a) and either the MS stereo on/off decision section 3 decides the value of the correlation degree (step C3b, C4b or C5b) or compares the value of the correlation degree with a next coefficient. Then, if the area ratio is equal to or higher than 0.75, then the MS stereo on/off decision section 3 decides that the correlation degree is 0 (step C6). After the correlation degree is decided at any of steps C1b to C5 and C6, the MS stereo on/off decision section 3 inputs the decided correlation degree to the bit number allocation section 4 (step C7). Thereafter, the processing returns to the main flow.

In this manner, the MS stereo on/off decision section 3 multiplies the power pow_M by a coefficient and compares the value obtained by the multiplication with the power pow_S to determine the correlation degree.

5-4. Process of the Bit Number Allocation Section 4

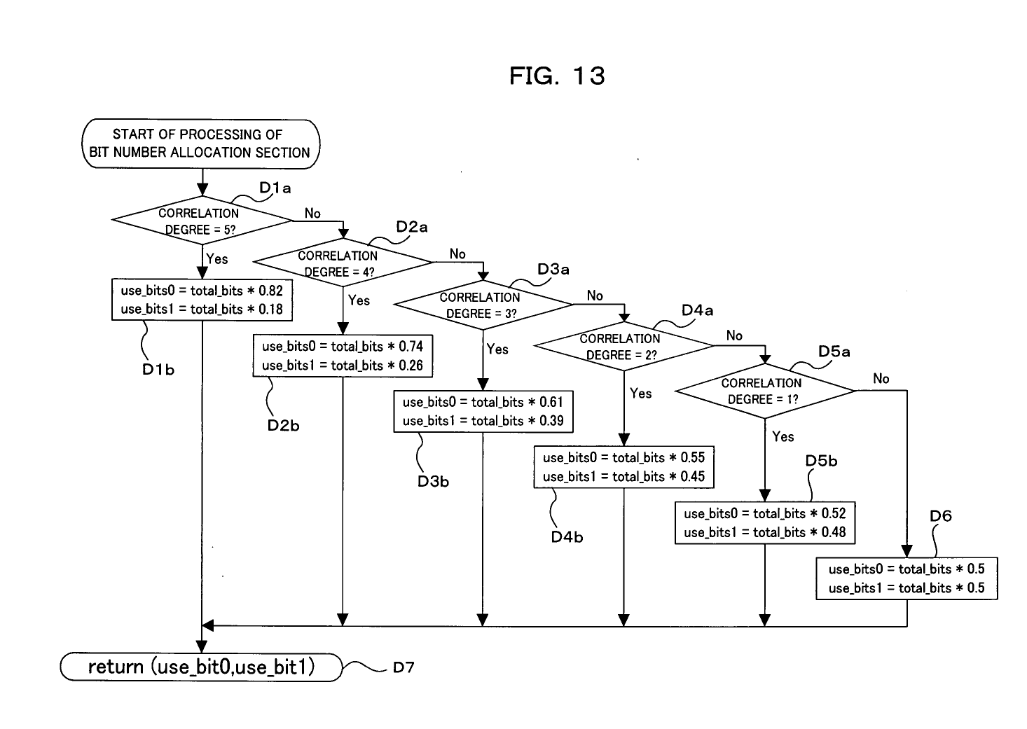

FIG. 13 is a flow chart illustrating a process of the bit number allocation section 4 according to the first embodiment of the present invention and illustrates particulars of the process at step A10 of the flow chart shown in FIG. 10.

Referring to FIG. 13, the bit number allocation section 4 decides at step D1a whether or not the correlation degree is 5. If the correlation degree is 5, then the processing follows a Yes route, and at step D1b, the bit number allocation section 4 multiplies the total bit number total_bits by a coefficient 0.82 (refer to FIG. 8) and allocates a resulting value total_bits*0.82 as the bit number use_bits0 to be allocated to the M channel. Similarly, the bit number allocation section 4 allocates the product total_bits*0.18 of the total bit number total_bits and another coefficient 0.18 as the bit number use_bits1 to the S-channel signal.

On the other hand, if the correlation degree is not 5 at step D1a, then the processing follows a No route, and at step D2a, the bit number allocation section 4 decrements the correlation degree 5 and decides whether or not the correlation degree is 4.

Similarly, at steps D3a, D4a and D5a, the bit number allocation section 4 decides whether or not the correlation degree is 3, 2 and 1, respectively. If the result of the decision coincides 3, 2 or 1, then the processing follows a No route, and the bit number allocation section 4 determines the bit number use_bits0 of the M-channel and the bit number use_bits1 of the S-channel (step D2b, D3b, D4b or D5b). On the other hand, if the decision result does not coincide with 3, 2 or 1, then the correlation degree is successively decremented.

If the correlation degree is not 1 at step D5a, then the bit number allocation section 4 allocates the bit number use_bits0 and the bit number use_bits1 equal to each other to the M-channel and the S-channel (step D6). Then, after the process at any of steps D1b to D6 is performed, the bit number allocation section 4 inputs the bit numbers use_bits0 and use_bits1 allocated to the M-channel and the S-channel to the quantization•encoding section 8 (step D7).

In this manner, the bit number allocation section 4 weights the total bit number total_bits in accordance with the correlation degree to determine the bit numbers use_bits0 and use_bits1 to be used in the quantization and encoding processes for the channels ch0 and ch1.

5-5. Process by the MS Stereo Processing Section 7

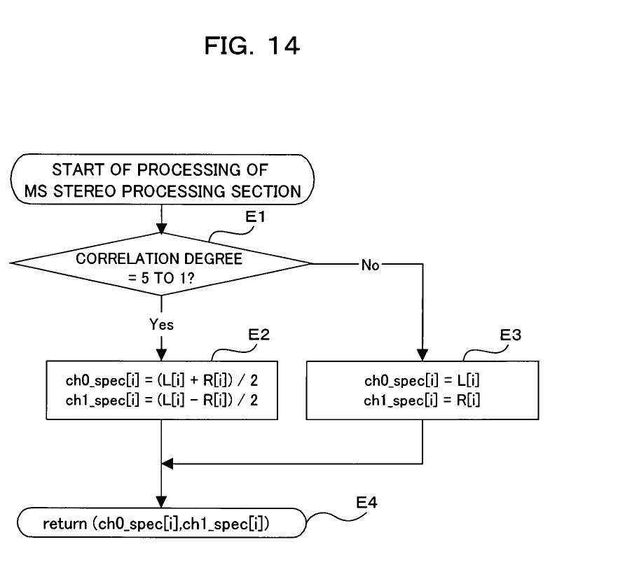

FIG. 14 illustrates particulars of the process by the MS stereo processing section 7 according to the first embodiment of the present invention. Referring to FIG. 14, the processing of the MS stereo processing section 7 follows a Yes route while the correlation degree remains within the range from 5 to 1 to establish an MS stereo on state (step E1), and at step E2, the MS stereo processing section 7 calculates a sum signal and a difference signal for each frequency component of the L-channel and the R-channel and then calculates an M-channel spectrum signal ch0_spec[i] representative of each frequency component of the M-channel signal ch0 and an S-channel spectrum signal ch1_spec[i] representative of each frequency component of the S-channel signal ch1.

On the other hand, if the correlation degree is 0 at step E1, then the processing follows a No route, and at step E3, the MS stereo processing section 7 establishes an MS stereo off state and sets the frequency components ch0_spec[i] and ch0_spec[0] of the M-channel signal ch0 and the S-channel signal ch1 to L[i] and R[i], respectively. Further, at step E4 after the process at step E2 or E3, the MS stereo processing section 7 inputs the frequency components ch0_spec[i] and ch0_spec[0] to the quantization•encoding section 8.

In this manner, according to the audio encoding apparatus 30 of the present invention, since a correlation degree is used to control the MS stereo function between on and off to appropriately control the bit allocation, for example, when the sensitivity drops in the MS stereo state, the MS stereo state can be turned off to maintain the audibility.

Furthermore, in calculation of a cross-correlation coefficient and spectrum calculation, the dynamic range of a PCM signal is narrow when compared with the dynamic range of results of calculation of the cross-correlation coefficient and the spectrum calculation. Therefore, it is facilitated to assure the accuracy of the results, and this contributes very much to the quality and the reliability of the audio encoding apparatus 30.

6. Description of a Modification

In order to obtain a correlation degree, a different configuration from that of the LR-MS conversion section 1 or the power calculation section 2 shown in FIG. 2 may be used.

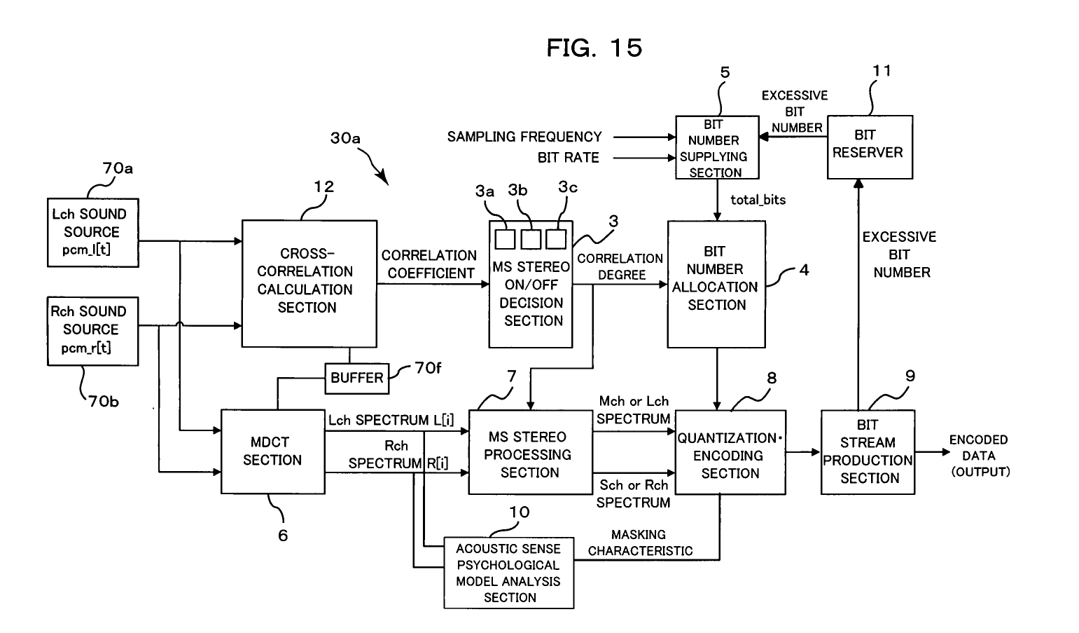

FIG. 15 is a block diagram showing an audio encoding apparatus according to a modification to the first embodiment of the present invention. The modified audio encoding apparatus 30a shown in FIG. 15 is different from the audio encoding apparatus 30 in that a cross-correlation calculation section 12 is provided in place of the LR-MS conversion section 1 and the power calculation section 2 between the input side and the MS stereo on/off decision section 3.

The correlation degree calculation section 3a calculates a cross-correlation coefficient between the L-channel PCM signal and the R-channel PCM signal and inputs the cross-correlation coefficient as a correlation degree (correlation coefficient) to the MS stereo on/off decision section 3. For the correlation degree, data of 0 to 5 recorded in the decision table 3c can be used. It is to be noted that, in FIG. 15, like elements to those described hereinabove are denoted by like reference characters.

In the audio encoding apparatus 30a having the configuration described above, the cross-correlation calculation section 12 calculates a cross-correlation coefficient based on PCM signals outputted from the L-channel PCM signal production section 70a and the R-channel PCM signal production section 70b and inputs a correlation coefficient corresponding to a result of the calculation to the MS stereo on/off decision section 3. Then, the MS stereo on/off decision section 3 determines a correlation degree value based on the magnitude of the correlation coefficient inputted thereto. After the determination, the audio encoding apparatus 30a performs various processes similarly to those described hereinabove.

In this manner, also where a cross-correlation coefficient is used, similar effects to those described above can be achieved. Further, the calculation amount can be reduced as well.

### B. Description of the Second Embodiment of the Present Invention

In the first embodiment, the PCM signals from the L-channel PCM signal production section 70a and the R-channel PCM signal production section 70b are both time base signals and are converted into signals of the M-channel and the S-channel and audio encoded in the time domain.

In the second embodiment, however, calculation of a waveform area is performed in the frequency domain. Further, an audio recording and reproduction system in the second embodiment is same as the audio recording and reproduction system 100.

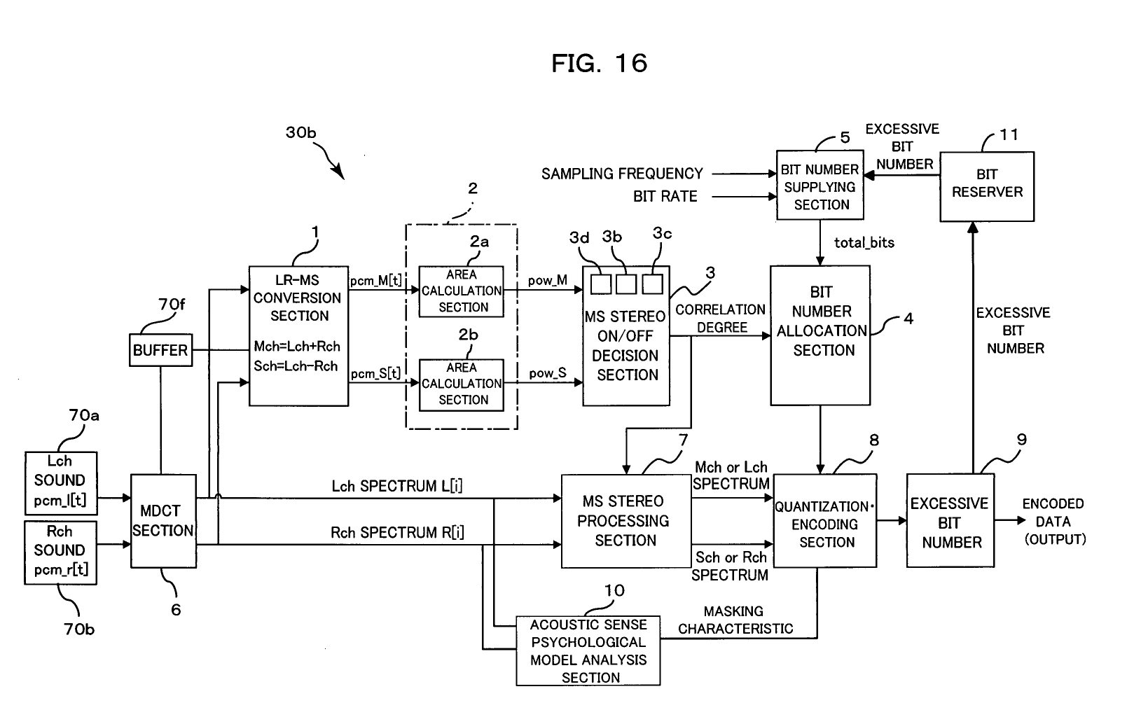

FIG. 16 is a block diagram of an audio encoding apparatus according to the second embodiment of the present invention. Referring to FIG. 16, the audio encoding apparatus 30b shown performs stereo audio encoding of an L-channel PCM signal and an R-channel PCM signal. The audio encoding apparatus 30b is different from the audio encoding apparatus 30 and 30a in that the PCM signals from the L-channel PCM signal production section 70a and the R-channel PCM signal production section 70b are inputted to the MDCT processing section 6 but not to the LR-MS conversion section 1.

The MDCT processing section 6 converts the L-channel PCM signal and the R-channel PCM signal into L-channel spectral data and R-channel spectral data in the frequency domain.

The MS stereo on/off decision section 3 includes a second correlation degree calculation section 3d in place of the correlation degree calculation section 3a. The second correlation degree calculation section 3d calculates, based on the L-channel spectral data and the R-channel spectral data transformed by the MDCT processing section 6, the correlation degree between the L-channel spectral data and the R-channel spectral data. The second correlation degree calculation section 3d calculates the correlation degree based on the power of difference spectral data between the L-channel spectral data and the R-channel spectral data transformed by the MDCT processing section 6 and the power of sum spectral data of the L-channel spectral data and the R-channel spectral data.

The comparison section 3b decides whether or not the stereo encoding process should be carried out based on the correlation degree calculated by the second correlation degree calculation section 3d.

Further, the bit number allocation section 4 allocates, based on a result of the decision by the MS stereo on/off decision section 3, frame regions into which a sum signal and a difference signal of the L-channel PCM signal and the R-channel PCM signal are to be stored. If it is decided by the MS stereo on/off decision section 3 that the stereo encoding process should be carried out, then the bit number allocation section 4 allocates the frame regions in accordance with the correlation degree. However, if it is decided by the MS stereo on/off decision section 3 that the stereo encoding process should not be carried out, then the bit number allocation section 4 allocates equal frame regions. Then, the bit number allocation section 4 changes the frame regions based on excessive bit number information of the audio encoded frame.

The quantization•encoding section 8 functions as audio encoding means for encoding the S-channel signal and the M-channel signal based on the frame regions allocated by the bit number allocation section 4. Following the MDCT process, similar processes to those described hereinabove in connection with the first embodiment are performed. It is to be noted that, in FIG. 16, like elements to those described hereinabove are denoted by like reference characters.

In the audio encoding apparatus 30b having the configuration described above, PCM signals of the L-channel and the R-channel inputted are MDCT processed by the MDCT processing section 6, and spectral data (spectrum information) of the L-channel and the R-channel obtained by the MDCT process are converted into M-channel spectral data and S-channel spectral data, respectively. Then, the area calculation sections 2a and 2b calculate the areas regarding spectral data of the M-channel and the S channel, and the comparison section 3b decides the correlation degree between the L-channel and the R-channel based on the area ratio between the spectral data of the M-channel and the S channel. In particular, each of the area calculation sections 2a and 2b decides the correlation degree of the L-channel and the R-channel based on the power obtained by the calculation of the waveform area and controls the MS stereo function to on or off.

In this manner, the audio encoding apparatus 30b of the second embodiment converts spectral data of the L-channel and the R-channel obtained by the MDCT process for the PCM signals inputted thereto into spectral data of the M-channel and the S channel, calculates the powers of the M-channel and the S-channel after the conversion, decides the correlation degree of the L-channel and the R-channel based on the powers and then controls the MS stereo function to on/off.

B1. Modification

It is to be noted that it is otherwise possible for the MS stereo on/off decision section 3 to use a cross-correlation coefficient to perform a decision process.

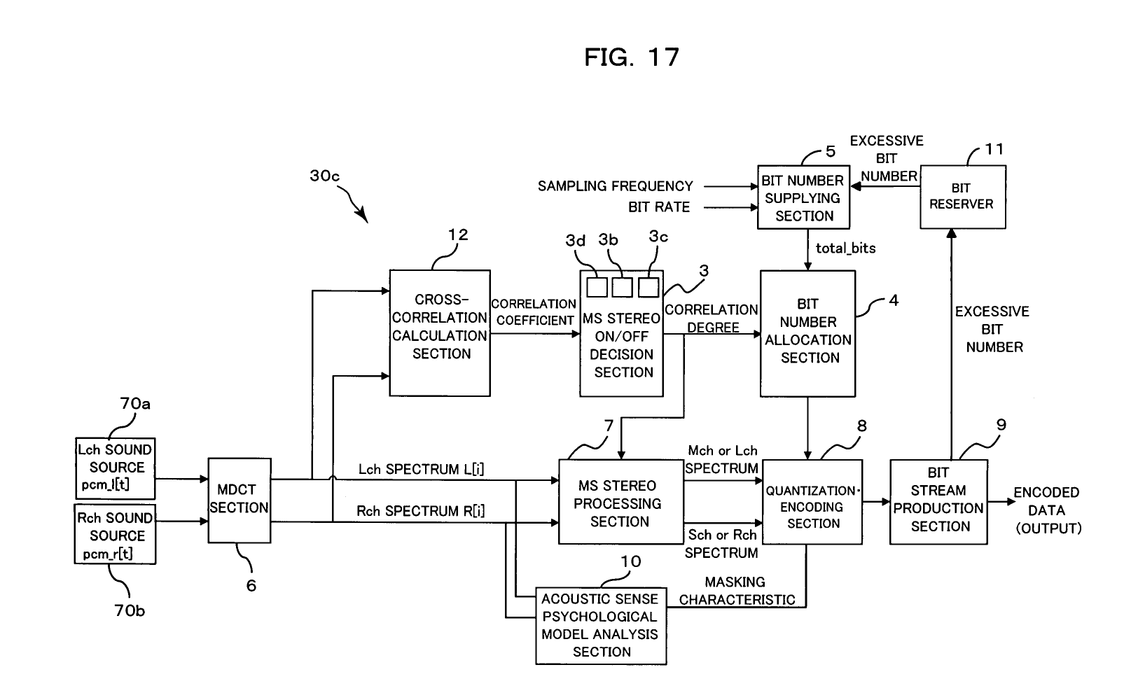

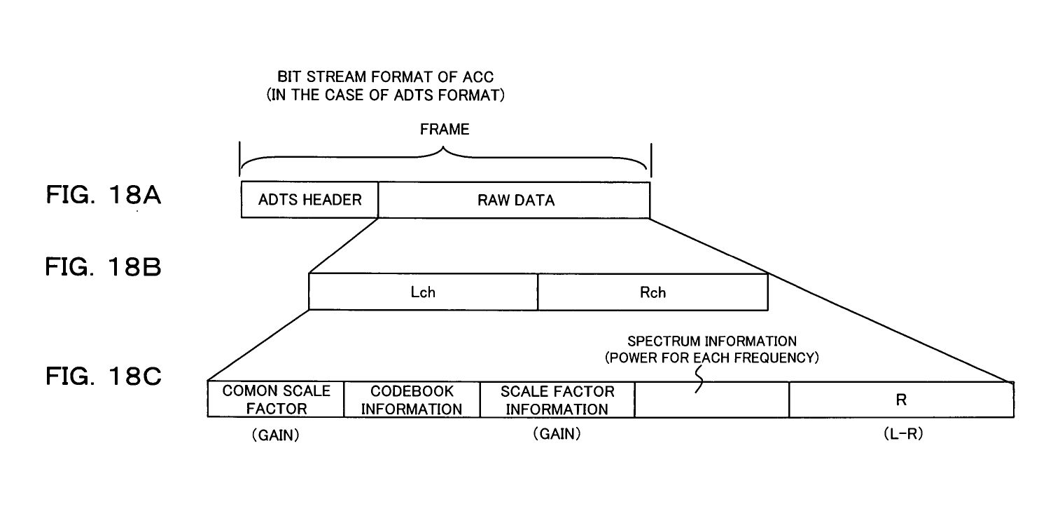

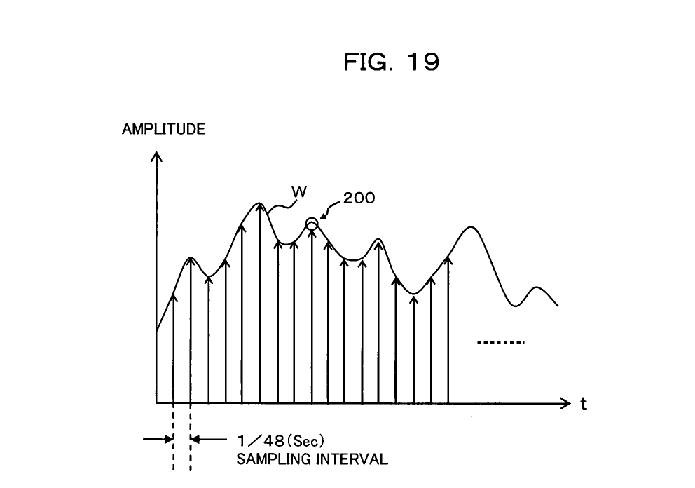

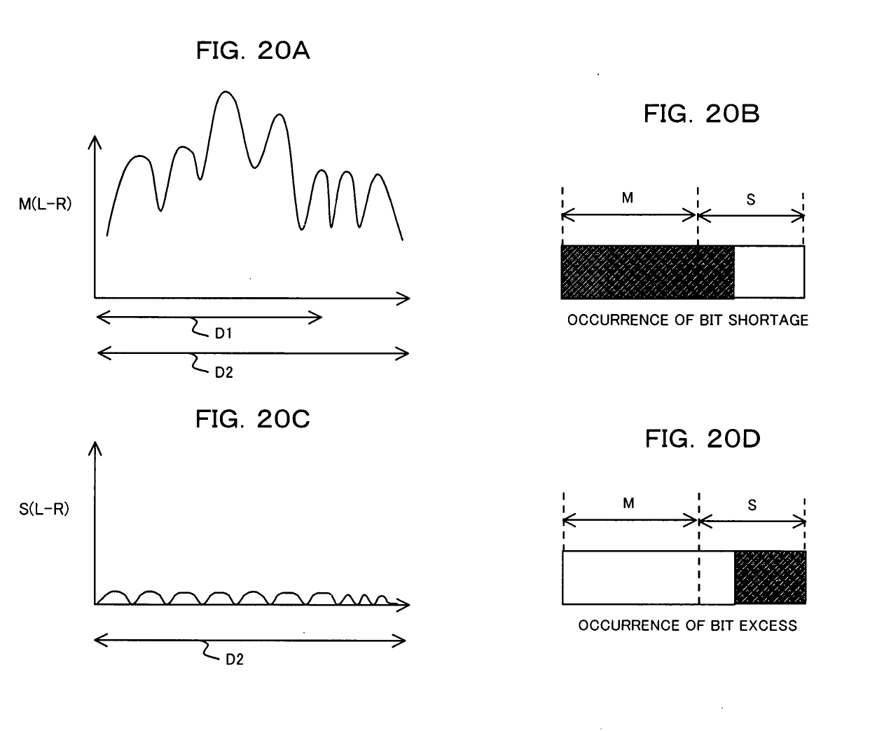

FIG. 17 is a block diagram of an audio encoding apparatus according to a modification to the second embodiment of the present invention. Referring to FIG. 17, the audio encoding apparatus 30c shown can use a cross-correlation coefficient to perform a decision process. Then, a cross-correlation coefficient between the PCM signals of the L-channel and the R-channel transformed by the MDCT processing section 6 is calculated by the cross-correlation calculation section 12. In particular, the second correlation degree calculation section 3d calculates a cross-correlation coefficient between the L-channel PCM signal and the R-channel PCM signal and inputs the cross-correlation coefficient as a correlation degree to the MS stereo on/off decision section 3. For the cross-correlation function, data of 0 to 5 recorded in the decision table 3c can be used.

It is to be noted that, in FIG. 17, like elements to those described hereinabove are denoted by like reference characters.

The audio encoding apparatus 30b of the present modification having the configuration described above calculates a cross-correlation coefficient between spectrum information of the L-channel and the R-channel obtained by the MDCT process of inputted PCM signals and controls the MS stereo function between on and off based on the value of the cross-correlation coefficient.

In this manner, also where a correlation coefficient is used, similar effects to those described hereinabove can be achieved. Further, also it is possible to reduce the calculation amount.

In this manner, the correlation degree in the second embodiment is obtained by one of a method wherein PCM signals in the time domain are converted into PCM signals in the frequency domain and the powers of the spectral data obtained by the conversion are used and another method wherein the magnitude of the cross-correlation coefficient of spectra of the L-channel and the R-channel is used, and based on the correlation degree, it is decided whether the MS stereo function should be turned on or off.

### C. Comparison with the Prior Art Apparatus

The acoustic signal processing circuit disclosed in the Patent Document 1 uses, upon encoding of a signal spectrum of a reference channel and a difference spectrum between channels, the power ratio between the spectra to normally allocate the encoded bit number to each of the spectra.

Meanwhile, in the acoustic signal process disclosed in the Patent Document 1, information of both of the reference spectrum and the otheR-channel is included in the difference spectrum, and upon encoding, quantization errors for the 2 channels appear. The appearance of quantization errors signifies that, when the decoding apparatus side decodes the difference spectrum, also errors on the reference channel side appear. In other words, the one channel signal leaks to the otheR-channel signal, and this gives rise to appearance of noise. Here, if the correlation between the 2 channels is high, then since the power of the difference spectrum is low, the acoustic signal processing circuit cannot detect the noise described above. However, when the power of the difference spectrum is high, the noise described above can be detected and gives rise to degradation of the sound quality.

Accordingly, the acoustic signal processing circuit disclosed in the Patent Document 1 turns off the MS stereo process when the correlation degree between the two channels is low and therefore cannot detect the noise or suppress appearance of noise caused by leakage of a channel signal.

Also the Patent Documents 2 to 4 are silent of a technique for suppressing or moderating appearance of noise by leakage of a channel signal similarly to the Patent Document 1.

In contrast, the audio encoding apparatus 30, 30a and 30b of the present invention have a function of suppressing leakage between channels, and the leakage suppressing function is implemented by the MS stereo on/off decision section 3. The MS stereo on/off decision section 3 calculates the area ratio between the M-channel and the S-channel and compares a result of the calculation with a threshold value to control the MS stereo process between on and off.

In particular, the audio encoding apparatus 30, 30a and 30b turn on the MS stereo process when the correlation degree between the L-channel and the R-channel is high, but turn off the MS stereo process when the correlation degree is low. Further, when the MS stereo process is on, the MS stereo processing section 7 calculates a sum component and a difference component between the L-channel and the R-channel to produce an M-channel and an S channel. However, when the MS stereo process is off, the MS stereo processing section 7 produces none of an M-channel and an S channel.

### D. Others

The present invention is not limited to the embodiments or the modifications to them described hereinabove but can be carried out in various modified forms without departing from the spirit and scope of the present invention.

For example, the audio encoding apparatus 30, 30a, 30b and 30c and the audio encoding decision circuits of the present invention can process various stereo types including not only the dual-channels of the L-channel and the R-channel but can process multi-channel sampling signals such as surround channels having a high acoustic effect and multi-track channels of music, movies and so forth in a similar manner to duaL-channel signals. In the following, this is described taking a case wherein a plurality of parts (musical instruments) for playing music are recorded as a sound source and the correlation degree between j parts is calculated as an example.

The audio encoding apparatus of the present invention stereo audio encodes, for example, j (j is a natural number) different PCM sampling signals obtained by PCM sampling j parts which plays music. The audio encoding apparatus of the present invention includes a correlation degree calculation section 3a for calculating, based on j different PCM sampling signals, a correlation degree between the PCM sampling signals, an MS stereo on/off decision section 3 for deciding whether or not a stereo encoding process should be performed based on the correlation degree calculated by the correlation degree calculation section 3a, an allocation section 4 for allocating frame regions for individually storing j different arithmetic operation result signals obtained by arithmetic operation between the j sampling signals such as, addition, subtraction, multiplication, division, weighting and so forth based on the result of the decision by the MS stereo on/off decision section 3, and an audio encoding section for encoding the j arithmetic operation result signals based on the frame regions allocated by the allocation section 4.

In the audio encoding apparatus of the present invention, PCM sampling signals inputted are converted in the time domain or the frequency domain similarly as in the first and second embodiments described hereinabove, and j different correlation degrees are calculated and decision of stereo on/off and determination of bit distributions to individuaL-channels are performed based on a result of the calculation. Accordingly, efficient bit distributions to the j different channels can be anticipated, and this contributes to the improvement of the sound quality of the audio encoded signals.

In addition, the present invention can be applied not only to the audio recording and reproduction system 100 which uses the digital disk 53 but also to an audio data stream distribution or digital broadcasting system on the Internet and the like. Also in such systems, further improvement of the sound quality can be anticipated.

1. An audio encoding apparatus which performs a stereo audio encoding process of an L-channel sampling signal and an R-channel sampling signal, comprising:
a correlation degree calculation section for calculating, based on the L-channel sampling signal and the R-channel sampling signal, a correlation degree between the L-channel sampling signal and the R-channel sampling signal;
a decision section for deciding whether or not a stereo encoding process should be performed based on the correlation degree calculated by said correlation degree calculation section;
an allocation section for allocating frame regions for individually storing a difference signal and a sum signal between the L-channel sampling signal and the R-channel sampling signal based on a result of the decision by said decision section; and
audio encoding means for encoding the difference signal and the sum signal based on the frame regions allocated by said allocation section.

2. The audio encoding apparatus as claimed in claim 1, wherein said allocation section allocates the frame regions in accordance with the correlation degree calculated by said correlation degree calculation section.

3. The audio encoding apparatus as claimed in claim 1, wherein said correlation degree calculation section calculates the correlation degrees based on a power of the difference signal and a power of the sum signal.

4. The audio encoding apparatus as claimed in claim 1, wherein said correlation degree calculation section is formed from a processor having a fixed point accuracy.

5. The audio encoding apparatus as claimed in claim 4, wherein said correlation degree calculation section calculates the correlation degree based on an area ratio between a waveform area of the difference signal and a waveform area of the sum signal.

6. The audio encoding apparatus as claimed in claim 5, wherein, where the area ratio is low, said correlation degree calculation section increases the frame region for the sum signal and decreases the frame region for the difference signal, but where the area ratio is high, said correlation degree calculation section decreases an area difference between the frame area of the sum signal and the frame area of the difference signal.

7. The audio encoding apparatus as claimed in claim 1, wherein said correlation degree calculation section calculates a cross-correlation coefficient between the L-channel sampling signal and the R-channel sampling signal and inputs the calculated cross-correlation coefficient as the correlation degree to said decision section.

8. An audio encoding apparatus which performs a stereo audio encoding process of an L-channel sampling signal and an R-channel sampling signal, comprising:
a frequency conversion section for converting the L-channel sampling signal and the R-channel sampling signal into L-channel spectral data and R-channel spectral data of a frequency domain, respectively;
a second correlation degree calculation section for calculating a correlation degree between the L-channel spectral data and the R-channel spectral data based on the L-channel spectral data and the R-channel spectral data converted by said frequency conversion section;
a decision section for deciding whether or not a stereo encoding process should be performed based on the correlation degree calculated by said second correlation degree calculation section;
an allocation section for allocating frame regions for individually storing a difference signal and a sum signal between the L-channel sampling signal and the R-channel sampling signal based on a result of the decision by said decision section; and
audio encoding means for encoding the difference signal and the sum signal based on the frame regions allocated by said allocation section.

9. The audio encoding apparatus as claimed in claim 8, wherein said second correlation degree calculation section calculates the correlation degree based on a power of difference spectral data between the L-channel spectral data and the R-channel spectral data converted by said frequency conversion section and a power of sum spectral data between the L-channel spectral data and the R-channel spectral data.

10. The audio encoding apparatus as claimed in claim 8, wherein said second correlation degree calculation section calculates a cross-correlation coefficient between the L-channel spectral data and the R-channel spectral data and inputs the calculated cross-correlation coefficient as the correlation degree to said decision section.

11. The audio encoding apparatus as claimed in claim 1, wherein, where it is decided by said decision section that the stereo encoding process should be performed, said allocation section allocates the frame regions in accordance with the correlation degree, but where it is decided by said decision section that the stereo encoding process should not be performed, said allocation section allocates the frame regions equally.

12. The audio encoding apparatus as claimed in claim 8, wherein, where it is decided by said decision section that the stereo encoding process should be performed, said allocation section allocates the frame regions in accordance with the correlation degree, but where it is decided by said decision section that the stereo encoding process should not be performed, said allocation section allocates the frame regions equally.

13. The audio encoding apparatus as claimed in claim 1, wherein said allocation section changes the frame regions based on information regarding a surplus region of a frame for which the audio encoding process is performed.

14. The audio encoding apparatus as claimed in claim 8, wherein said allocation section changes the frame regions based on information regarding a surplus region of a frame for which the audio encoding process is performed.

15. An audio encoding apparatus which performs a stereo audio encoding process of a plurality of sampling signals produced by sampling a sound source, comprising:
a correlation degree calculation section for calculating a correlation degree between the sampling signals based on the sampling signals;
a decision section for deciding whether or not a stereo encoding process should be performed based on the correlation degree calculated by said correlation degree calculation section;
an allocation section for allocating frame regions for individually storing a plurality of arithmetic operation result signals obtained by arithmetic operation between the sampling signals based on the result of the decision by said decision section; and
audio encoding means for encoding the arithmetic operation result signals based on the frame regions allocated by said allocation section.

16. A frame region allocation circuit for an audio encoding apparatus which performs a stereo audio encoding process of an L-channel sampling signal and an R-channel sampling signal, comprising:
a correlation degree calculation section for calculating, based on the L-channel sampling signal and the R-channel sampling signal, a correlation degree between the L-channel sampling signal and the R-channel sampling signal;
a decision section for deciding whether or not a stereo encoding process should be performed based on the correlation degree calculated by said correlation degree calculation section; and
an allocation section for allocating frame regions for individually storing a difference signal and a sum signal between the L-channel sampling signal and the R-channel sampling signal based on a result of the decision by said decision section.
